(19) United States
(12) Patent Application Publication
(10) Pub. No.: US 2024/0184445 A1
(43) Pub. Date: Jun. 6, 2024

(54) CONTROL APPARATUS

(71) Applicant: Panasonic Intellectual Property Management Co., Ltd., Osaka (JP)

(72) Inventor: Atsushi HIRAI, Tokyo (JP)

(73) Assignee: Panasonic Intellectual Property Management Co., Ltd., Osaka (JP)

(21) Appl. No.: 18/524,811

(22) Filed: Nov. 30, 2023

(30) Foreign Application Priority Data
Dec. 2, 2022 (JP) 2022-193227

(51) Int. Cl. G06F 3/04886

(52) U.S. Cl. CPC G06F 3/04886

(57) ABSTRACT

In a control apparatus, a coordinate reception unit receives spatial coordinates of a detection object located in front of a display surface of a display. A setting unit sets a first determination region associated with first character information included in a first character information group based on coordinates of a first display region in which information on the first character information group is displayed on the display surface and spatial coordinates of the detection object at a reference time that is a time when the first display region is designated by the detection object. After the first determination region is set, a determination unit determines whether or not the detection object is located in the first determination region. A display output unit displays the first character information in the first display region when the determination unit determines that the detection object is located in the first determination region.

### BACKGROUND

### 1. Field

The present disclosure relates to a control apparatus.

### 2. Description of the Related Art

An information processing apparatus that stores virtual keys, which are keys of a virtual keyboard arranged in a space, in association with a plurality of hierarchies is known (see, for example, Patent Literature 1). In this information processing apparatus, the location of the instruction medium in the space is specified, and in a case where the instruction medium is located in the region corresponding to the hierarchies, the virtual keys stored in association with the hierarchies are displayed on the display screen.
[Patent Literature 1] JP 2014-82605 A

### SUMMARY

Further improvement is required in a control apparatus that accepts control inputs by the user.

In order to solve the above problem, a control apparatus according to one aspect of the present disclosure includes: a coordinate reception unit structured to receive spatial coordinates of a detection object located in front of a display surface of a display; a setting unit structured to set a first determination region associated with first character information included in a first character information group based on coordinates of a first display region in which information on the first character information group is displayed on the display surface and spatial coordinates of the detection object at a reference time that is a time when the first display region is designated by the detection object; a determination unit structured to determine whether or not the detection object is located in the first determination region after the first determination region is set; and a display output unit structured to display the first character information in the first display region in a case where the determination unit determines that the detection object is located in the first determination region.

Another aspect of the present disclosure is also a control apparatus. The apparatus includes: a coordinate reception unit structured to receive spatial coordinates of a first detection object and a second detection object located in front of a display surface of a display; a setting unit structured to set a first determination region associated with first character information included in a first character information group based on spatial coordinates of the first detection object at a reference time that is a time when a predetermined input start condition is satisfied, and set a second determination region associated with second character information included in a second character information group based on spatial coordinates of the second detection object at the reference time; a determination unit structured to determine whether or not the first detection object is located in the first determination region and whether or not the second detection object is located in the second determination region after the first determination region and the second determination region are set; and a display output unit structured to display the first character information in a first display region of the display surface in a case where the determination unit determines that the first detection object is located in the first determination region, and display the second character information in a second display region of the display surface in a case where the determination unit determines that the second detection object is located in the second determination region.

Still another aspect of the present disclosure is also a control apparatus. The apparatus includes: a coordinate reception unit structured to receive spatial coordinates of a detection object located in front of a display surface of a display; a setting unit structured to set a first determination region associated with first character information with reference to spatial coordinates of the detection object when the detection object enters a predetermined input space; a determination unit structured to determine whether or not the detection object is located in the first determination region after the first determination region is set; and a display output unit structured to display the first character information on the display surface in a case where the determination unit determines that the detection object is located in the first determination region.

### BRIEF DESCRIPTION OF THE DRAWINGS

FIG. 1 is a block diagram of an information processing system of a first embodiment;

FIG. 2 is a plan view of a display for describing a character input operation in the information processing system in FIG. 1;

FIGS. 3A to 3C are diagrams for describing a character input operation following FIG. 2;

FIGS. 4A and 4B are diagrams for describing a character input operation following FIGS. 3A to 3C;

FIG. 5 is a flowchart showing a process of the information processing system in FIG. 1;

FIGS. 6A and 6B are plan views of a display for describing another example of the operation of designating a display region in the information processing system in FIG. 1;

FIGS. 7A to 7C are diagrams showing another example of a determination region in the information processing system in FIG. 1;

FIGS. 8A to 8C are diagrams for describing a character input operation in the information processing system of a second embodiment;

FIG. 9 is a plan view of a display for describing a character input operation in the information processing system of a third embodiment;

FIG. 10 is a plan view of a display for describing a character input operation following FIG. 9;

FIG. 11 is a flowchart showing a process of the information processing system of the third embodiment;

FIG. 12 is a perspective view of a display for describing a character input operation in the information processing system of a fourth embodiment;

FIGS. 13A and 13B are diagrams for describing a character input operation following FIG. 12;

FIG. 14 is a flowchart showing a process of the information processing system of the fourth embodiment;

FIG. 15 is a plan view of a display for describing a character input operation in the information processing system of a fifth embodiment;

FIG. 16 is a plan view of a display for describing a character input operation following FIG. 15;

FIG. 17 is a plan view of a display for describing a character input operation following FIG. 16;

FIG. 18 is a plan view of a display for describing another example of the character input operation in the information processing system of the fifth embodiment;

FIG. 19 is a plan view of a display for describing a character input operation following FIG. 18;

FIG. 20 is a flowchart showing a process of the information processing system of the fifth embodiment;

FIG. 21 is a flowchart following FIG. 20;

FIGS. 22A and 22B are diagrams for describing a first example of a character input operation in the information processing system of a sixth embodiment;

FIGS. 23A and 23B are diagrams for describing a second example of the character input operation in the information processing system of the sixth embodiment;

FIG. 24 is a plan view of a display for describing a third example of the character input operation in the information processing system of the sixth embodiment;

FIG. 25 is a plan view of a display for describing a fourth example of the character input operation in the information processing system of the sixth embodiment;

FIGS. 26A and 26B are diagrams for describing a fifth example of the character input operation in the information processing system of the sixth embodiment;

FIGS. 27A and 27B are diagrams showing various setting examples of a determination region in the information processing system;

FIGS. 28A to 28D are diagrams showing another setting example of the determination region in the information processing system;

FIGS. 29A and 29B are diagram showing still another setting example of the determination region in the information processing system;

FIG. 30 is a perspective view of a display for describing a character input operation in the information processing system of a seventh embodiment;

FIG. 31 is a diagram for describing a character input operation following FIG. 30;

FIGS. 32A and 32B are diagrams showing another setting example of a plurality of determination regions of the seventh embodiment;

FIGS. 33A to 33D are diagrams for describing size change processing of a determination region in the information processing system of the seventh embodiment; and

FIGS. 34A to 34C are diagrams for describing a character input operation in an information processing system of a modification of the first embodiment.

### DETAILED DESCRIPTION

The invention will now be described by reference to the preferred embodiments. This does not intend to limit the scope of the present invention, but to exemplify the invention.

Hereinafter, identical or like constituting elements, members, steps shown in the drawings are represented by identical symbols, and a duplicate description will be omitted as appropriate. The dimension of members in the drawings shall be enlarged or reduced as appropriate to facilitate understanding.

### First Embodiment

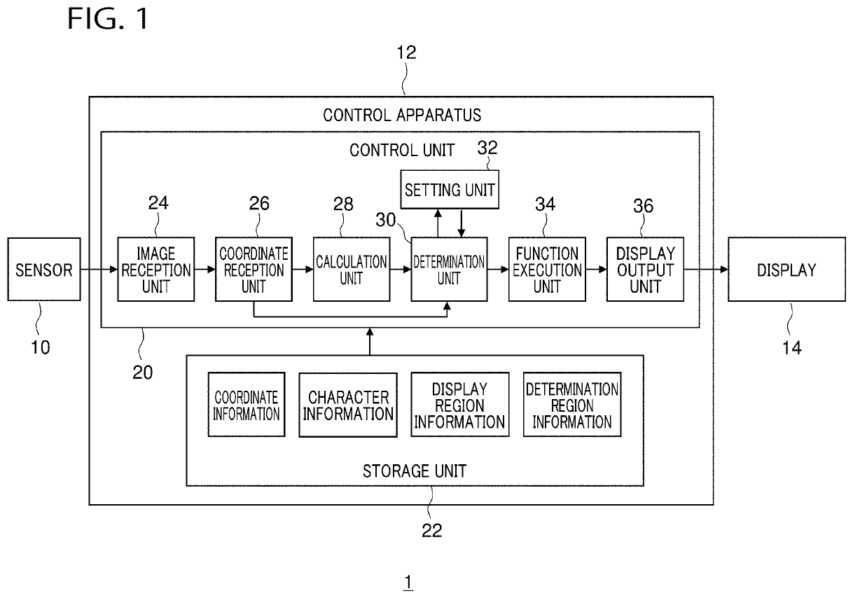

FIG. 1 is a block diagram of an information processing system 1 of the first embodiment. The information processing system 1 includes a sensor 10, a control apparatus 12, and a display 14.

The information processing system 1 may be installed indoors or the like, or may be mounted on a vehicle such as an automobile, and the application thereof is not particularly limited. The user can select a character and input the selected character to the control apparatus 12 by performing a character input operation of moving the fingertip of the hand in the air without touching the display 14. The character input operation can also be referred to as an aerial touch operation or a gesture operation.

The sensor 10 is, for example, a depth camera, and is installed at a location where a user located in front of the display surface of the display 14 can be imaged. The sensor 10 periodically images an image of the user, and outputs the imaged time-series range images to the control apparatus 12. The frequency of imaging can be appropriately determined by experiment or simulation, and may be, for example, a plurality of times per second. The range images include information of spatial coordinates of each location in the images. The spatial coordinates are coordinates in a three-dimensional Cartesian coordinate system specific to the sensor 10.

The control apparatus 12, based on the time-series range images supplied from the sensor 10, recognizes the movement of the user's fingertip and accepts a character input according to the movement of the fingertip. The control apparatus 12 executes a process based on the accepted characters.

The fingertip is an example of the detection object used for control inputs, and the detection object is not limited to the fingertip. Another example of the detection object is a first that is a part of the user's body. The detection object is not limited to a part of the user's body, and may be an object held by the user's hand or an object worn on the user's body.

The display 14 displays an image according to the control by the control apparatus 12. The display 14 may have, for example, a screen size of several tens of inches or more for indoor installation or a smaller screen size for in-vehicle use.

As shown in FIG. 1, the control apparatus 12 includes a control unit 20 and a storage unit 22. The control unit 20 has an image reception unit 24, a coordinate reception unit 26, a calculation unit 28, a determination unit 30, a setting unit 32, a function execution unit 34, and a display output unit 36.

The features of the control unit 20 are implemented in hardware such as a CPU, a memory, and other LSIs of any computer and in software such as a program loaded into a memory. The figure depicts functional blocks implemented by the cooperation of these elements. Therefore, it will be understood by those skilled in the art that these functional blocks may be implemented in a variety of manners by hardware only, software only, or by a combination of hardware and software. The control apparatus 12 includes, for example, a processor and a memory, and the processor executes a program loaded into the memory, thereby realizing the functions of the control unit 20 and the respective function blocks that the control unit 20 has.

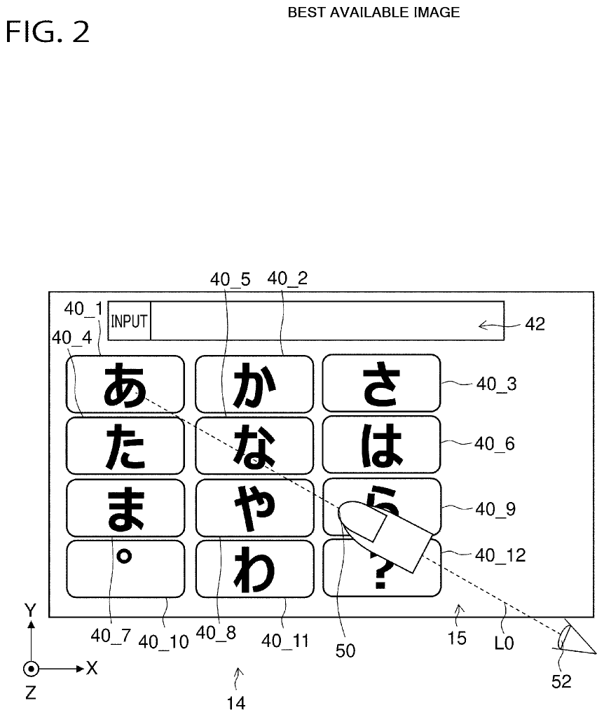

The storage unit 22 stores various types of information. The storage unit 22 is realized by hardware for storing information (in other words, data), such as a memory or a storage. The storage unit 22 holds coordinate information, character information, display region information, and determination region information. The coordinate information includes spatial coordinates of the installation location of the sensor 10, an attachment angle of the sensor 10, and spatial coordinates of the installation location of the display 14. The character information includes information for identifying a plurality of character information groups and character information included in each of the plurality of character information groups. The display region information includes information on the center coordinates and the size of each of the plurality of display regions, and information on the correspondence relationship between the display regions and the character information groups. The determination region information includes information on the sizes of the plurality of determination regions. Details of the coordinate information, the character information, the display region information, and the determination region information will be described later. FIG. 2 is a plan view of the display 14 for describing a character input operation in the information processing system 1 in FIG. 1. In FIG. 2, a part of the display surface 15 of the display 14 is shown, and illustrations of the sensor 10 and the control apparatus 12 are omitted.

Hereinafter, an example in which the control apparatus 12 accepts an input of Japanese hiragana characters will be described. The characters that can be input are not particularly limited, and the control apparatus 12 may accept input of katakana characters in Japanese, may accept input of numbers as described later, or may accept input of characters in an arbitrary language such as English.

The five characters “ [symbol] ” reading “a”, “ [symbol] ” reading “i”, “ [symbol] ” reading “u”, “ [symbol] ” reading “e”, and “ [symbol] ” reading “o” in the “ [symbol] ” reading “a” line are character information of the first character information group. The five characters in the “ [symbol] ” reading “ka” line are character information of the second character information group. The five characters in the “ [symbol] ” reading “sa” line are character information of the third character information group. The five characters in the “ [symbol] ” reading “ta” line are character information of the fourth character information group. The five characters in the “ [symbol] ” reading “na” line are character information of the fifth character information group. The five characters in the “ [symbol] ” reading “ha” line are character information of the sixth character information group. The five characters in the “ [symbol] ” reading “ma” line are character information of the seventh character information group. Three characters in the “ [symbol] ” reading “ya” line are character information of the eighth character information group. The five characters in the “ [symbol] ” reading “ra” line are character information of the ninth character information group. The semivoiced sound mark “ [symbol] ” and the voiced sound mark “ [symbol] ” are character information of the tenth character information group. The characters “ [symbol] ” reading “wa”, “ [symbol] ” reading “wo”, and “ [symbol] ” reading “n” in the “ [symbol] ” reading “wa” line are character information of the eleventh character information group. The symbols “?”, “°”, “ [symbol] ” and “ [symbol] ” “are character information of the twelfth character information group.

In FIG. 2, the display surface 15 displays an image in the initial state. The display surface 15 includes a first display region 40_1, a second display region 40_2, a third display region 40_3, a fourth display region 40_4, a fifth display region 40_5, a sixth display region 40_6, a seventh display region 40_7, an eighth display region 40_8, a ninth display region 40_9, a tenth display region 40_10, an eleventh display region 40_11, a twelfth display region 40_12, and an input display region 42. When these first display region 40_1 and others are not distinguished, they are referred to as the display region 40. The plurality of display regions 40 can also be referred to as screen keyboards. The display regions 40 and the character information groups are associated in advance on a one-to-one basis.

Based on the information on the correspondence relationship between the display regions 40 and the character information groups stored in the storage unit 22, the display output unit 36 displays the information on the character information group in the corresponding display region 40 for each of the plurality of character information groups in the image in the initial state. In the image in the initial state, the information on the character information group is, for example, information of characters representing the character information group. Information of characters representing the character information group can also be referred to as information for identifying the character information group.

In the first display region 40_1, the character “ [symbol] ” reading “a” and representing the first character information group is displayed. In the second display region 40_2, the character “ [symbol] ” reading “ka” and representing the second character information group is displayed. In the third display region 40_3, the character “ [symbol] ” reading “sa” and representing the third character information group is displayed. The same applies to the fourth display region 40_4 to the twelfth display region 40_12. As described below, the characters displayed in each of the display regions 40 can change according to the character input operation of the user.

Furthermore, as described later, characters input according to the character input operation of the user are displayed in the input display region 42.

FIG. 2 shows an X axis, a Y axis, and a Z axis of the three-dimensional Cartesian coordinate system of the information processing system 1. The Z axis extends in the normal line direction of the display surface 15 of the display 14. The X axis extends in the lateral direction of the display surface 15. The Y axis extends in the longitudinal direction of the display surface 15.

Hereinafter, an example in which the user inputs characters “ [symbol] ” reading “i” in the “ [symbol] ” reading “a” line will be described. As shown in FIG. 2, first, the user designates the first display region 40_1, in which the character “ [symbol] ” reading “a” is displayed, with the fingertip 50 without touching the display 14. Next, the user moves the fingertip 50 close to the first display region 40_1 until the character “ [symbol] ” reading “a” displayed in the first display region 40_1 changes to the character “ [symbol] ” reading “i”. In a case where the character “ [symbol] ” reading “i” is displayed in the first display region 40_1, the user performs a predetermined determination operation with the fingertip. As a result, the character “ [symbol] ” reading “i” is displayed in the input display region 42 and is input to the control apparatus 12. The user can input a plurality of characters by repeating these operations. This will be described in more detail below.

The image reception unit 24 detects the fingertip 50 and the eye 52 of the user by receiving time-series range images obtained by imaging the user located in front of the display 14 from the sensor 10 and performing image recognition on each of the received range images. A known image recognition technique can be used to detect the fingertip 50 and the eye 52. The image reception unit 24 acquires the spatial coordinates of each of the detected fingertip 50 and the detected eye 52 in time series.

The image reception unit 24 calculates time-series spatial coordinates of each of the fingertip 50 and the eye 52 of the user in the three-dimensional Cartesian coordinate system of the information processing system 1 based on the acquired spatial coordinates of each of the fingertip 50 and the eye 52 of the user in the coordinate system of the sensor 10, and the spatial coordinates of the installation location of the sensor 10 and the attachment angle of the sensor 10 included in the coordinate information stored in the storage unit 22. The image reception unit 24 supplies the calculated spatial coordinates to the coordinate reception unit 26. The coordinate reception unit 26 receives the spatial coordinates from the image reception unit 24, and outputs the received spatial coordinates to the calculation unit 28 and the determination unit 30. A process of the calculation unit 28 will be described later.

The determination unit 30 determines whether or not the fingertip 50 has designated any one of the plurality of display regions 40 based on the spatial coordinates of each of the fingertip 50 and the eye 52 supplied from the coordinate reception unit 26 and the center coordinates and the size information of each of the plurality of display regions 40 stored in the storage unit 22.

In a case where the display region 40 is on a straight line L0 going through the eye 52 and the fingertip 50, the determination unit 30 determines that the fingertip 50 has designated the display region 40 on the straight line L0. In a case where the display region 40 is not on the straight line L0 going through the eye 52 and the fingertip 50, the determination unit 30 determines that the fingertip 50 has not designated the display region 40. The determination unit 30 outputs a determination result to the setting unit 32. In a case where the determination unit 30 determines that the fingertip 50 has designated any of the plurality of display regions 40, the determination unit 30 also outputs the spatial coordinates of the fingertip 50 used for the determination to the setting unit 32. The spatial coordinates of the fingertip 50 used for the determination are the spatial coordinates of the fingertip 50 at the reference time that is a time when the display region 40 is designated with the fingertip 50.

In the example of FIG. 2, in order to designate the first display region 40_1, the user moves at least one of the fingertip 50 or the eye 52 such that the first display region 40_1 is located on the straight line L0. The determination unit 30 determines that the first display region 40_1 intersecting the straight line L0 is designated.

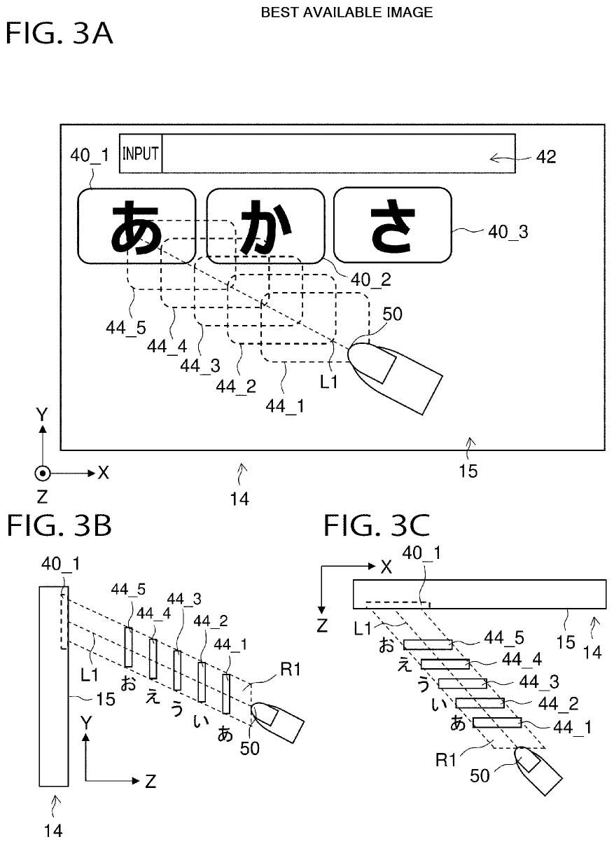

FIGS. 3A to 3C are diagrams for describing a character input operation following FIG. 2. FIG. 3A is a plan view of the display 14, FIG. 3B is a side view of the display 14, and FIG. 3C is a top view of the display 14. In FIG. 3A, the first display region 40_1, the second display region 40_2, and the third display region 40_3 in FIG. 2 are shown in an enlarged manner, and an illustration of other display regions 40 is omitted.

n is the number of display regions 40, and i is any integer from 1 to n. In a case where the determination unit 30 determines that the fingertip 50 has designated the i-th display region 40_i, the setting unit 32 sets the first determination region 44_1, the second determination region 44_2, the third determination region 44_3, the fourth determination region 44_4, and the fifth determination region 44_5 between the i-th display region 40_i and the fingertip 50 based on the coordinates of the i-th display region 40_i and the spatial coordinates of the fingertip 50 at the reference time supplied from the determination unit 30. When these first determination regions 44_1 and others are not distinguished, they are referred to as the determination region 44.

The setting unit 32 sets a straight line L1 for operation that connects the spatial coordinates of the fingertip 50 at the reference time and the i-th display region 40_i, and sets a plurality of determination regions 44 to intersect the straight line L1. The setting unit 32 may set a straight line L1 for operation that connects the spatial coordinates of the eye 52 at the reference time, the spatial coordinates of the fingertip 50 at the reference time, and the i-th display region 40_i. In this case, the straight line L1 for operation is identical to the straight line L0. The setting unit 32 may set a straight line L1 for operation that connects the spatial coordinates of the eye 52 at the reference time and the i-th display region 40_i.

The setting unit 32 sets, for example, a plurality of the same size determination regions 44 at equal intervals parallel to the display surface 15 based on the information on the sizes of the plurality of determination regions 44 stored in the storage unit 22. The determination region 44 can have any three-dimensional shape, for example, it can be plate-like, as in the examples shown in FIGS. 3A to 3C. The cross-sectional area and the shape of the determination region 44 in the cross-section parallel to the display surface 15 are not particularly limited, and may be equivalent to the area and the shape of the display region 40, for example, as in the examples shown in FIGS. 3A to 3C. From the fingertip 50 side to the display surface 15 side, the first determination region 44_1, the second determination region 44_2, the third determination region 44_3, the fourth determination region 44_4, and the fifth determination region 44_5 are arranged in this order. The setting unit 32 associates the plurality of character information included in the i-th character information group with the plurality of the determination regions 44 on a one-to-one basis.

In the examples in FIGS. 3A to 3C, the fingertip 50 designates the first display region 40_1, and therefore, the setting unit 32 sets a plurality of determination regions 44 that intersect the straight line L1 that connects the spatial coordinates of the fingertip 50 at the reference time and the center coordinates of the first display region 40_1. The first determination region 44_1 corresponds to the character “ [symbol] ” reading “a”, the second determination region 44_2 corresponds to the character “ [symbol] ” reading “i”, the third determination region 44_3 corresponds to the character “ [symbol] ” reading “u”, the fourth determination region 44_4 corresponds to the character “ [symbol] ” reading “e”, and the fifth determination region 44_5 corresponds to the character “ [symbol] ” reading “o”.

Also, in a case where the determination region 44 is set, the setting unit 32 sets the selection region R1 shown in FIG. 3B and FIG. 3C. The selection region R1 includes a plurality of determination regions 44 and has a three-dimensional shape. The cross-sectional area and the shape of the selection region R1 in the cross-section parallel to the display surface 15 are not particularly limited, and may be equivalent to the area and the shape of the determination region 44, for example, as in the examples shown in FIGS. 3A to 3C. The determination unit 30 determines whether or not the fingertip 50 is located in the selection region R1. In a case where the determination unit 30 determines that the fingertip 50 is located in the selection region R1, the setting unit 32 maintains the plurality of determination regions 44.

In a case where the determination unit 30 determines that the fingertip 50 is not located in the selection region R1, the setting unit 32 cancels the setting of the plurality of determination regions 44. In a case where the determination unit 30 determines that the fingertip 50 is not located in the selection region R1, the determination unit 30 again determines whether or not the fingertip 50 has designated one of the plurality of the display regions 40. In this case, the user can designate a new display region 40 with the fingertip 50.

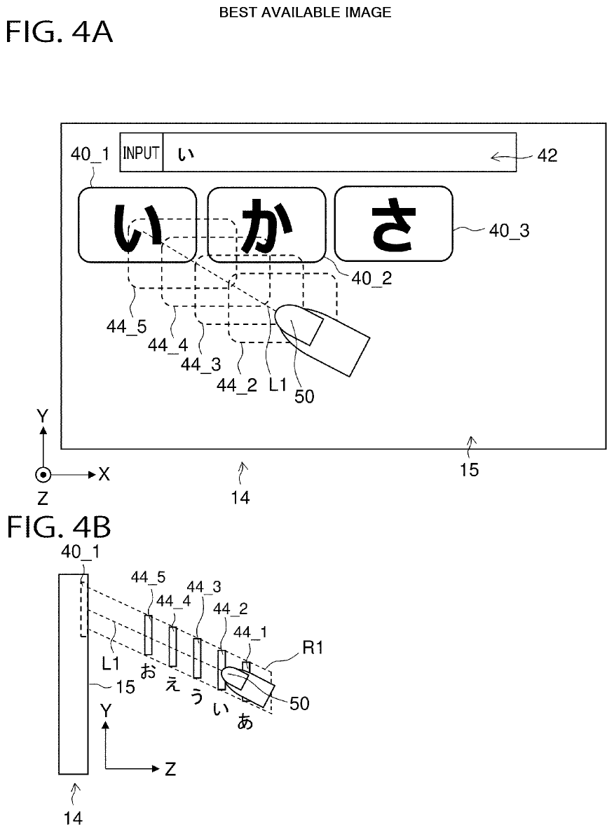

FIGS. 4A and 4B are diagrams for describing a character input operation following FIGS. 3A to 3C. FIG. 4A is a plan view of the display 14 and FIG. 4B is a side view of the display 14. As shown in FIGS. 4A and 4B, the user moves the fingertip 50 close to the first display region 40_1, and the fingertip 50 is in the second determination region 44_2 of the character “ [symbol] ” reading “i”.

After a plurality of determination regions 44 are set, the determination unit 30 determines whether or not the fingertip 50 is located in any of the determination regions 44, and outputs the determination results to the function execution unit 34. The determination result includes information to identify the determination region 44 in which the fingertip 50 is located.

In a case where the determination unit 30 determines that the fingertip 50 is located in any of the determination regions 44, the function execution unit 34 executes a process of changing the character information of the i-th display region 40_i for the image displayed on the display surface 15, based on the character information stored in the storage unit 22. The function execution unit 34 generates image data and supplies the image data to the display output unit 36.

The display output unit 36 outputs the image data supplied from the function execution unit 34 to the display 14 and displays the image on the display 14.

In other words, m is the number of the determination region and j is any integer from 1 to m. In a case where the determination unit 30 determines that the fingertip is located in the j-th determination region 44_j, the display output unit 36 displays the character information associated with the j-th determination region 44_j in the i-th display region 40_i.

The function execution unit 34 may highlight the characters in the i-th display region 40_i while the fingertip is located in the j-th determination region 44_j. Highlighting, for example, includes changing the color of the characters, changing the size of the characters, and so on. In a case where a plurality of determination regions 44 are set at intervals, by highlighting, the user can be made to recognize whether or not the fingertip 50 is located in the determination region 44, that is, whether or not it is possible to input characters at the position of the fingertip 50.

In the examples in FIGS. 4A and 4B, the fingertip 50 is located in the second determination region 44_2, and therefore, the display output unit 36 displays the character “ [symbol] ” reading “i” instead of the character “ [symbol] ” reading “a” in the first display region 40_1.

The calculation unit 28 calculates the trajectory of the fingertip 50 at a predetermined unit time based on the spatial coordinates supplied from the coordinate reception unit 26, and supplies the calculated trajectory information to the determination unit 30. The trajectory of the fingertip 50 is used to determine whether or not the determination operation has been performed. In a case where the determination operation is an operation to stop the fingertip 50 for a certain period of time, there may be no need to provide the calculation unit 28.

The determination unit 30 determines whether or not the determination operation has been performed with the fingertip 50 in the j-th determination region 44_j based on the spatial coordinates supplied from the coordinate reception unit 26 and the information on the trajectory of the fingertip 50 supplied from the calculation unit 28.

In a case where the determination unit 30 determines that the fingertip 50 is located in the j-th determination region 44_j and the determination operation has been performed, the function execution unit 34 determines character information associated with the j-th determination region 44_j and accepts an input of the character information. The function execution unit 34 may use the accepted character information to execute a process for a given application, or may supply the accepted character information to other processing devices not shown.

The function execution unit 34 executes a process of adding the accepted character information to the input display region 42 for the image displayed on the display surface 15.

In other words, in a case where the determination unit 30 determines that the fingertip 50 is located in the j-th determination region 44_j and the determination operation has been performed, the display output unit 36 displays the character information associated with the j-th determination region 44_j in the input display region 42.

In the examples in FIGS. 4A and 4B, the user performs the determination operation with the fingertip 50 when the character “ [symbol] ” reading “i” to be input is displayed in the first display region 40_1, that is, when the fingertip 50 is located in the first determination region 44_1. In response, the function execution unit 34 accepts an input of the character “ [symbol] ” reading “i”, which is the character information associated with the first determination region 44_1, and the display output unit 36 displays the character “ [symbol] ” reading “i” in the input display region 42.

In this way, according to the embodiment, the determination region 44 corresponding to the display region 40 designated by the user with the fingertip 50 can be set in the space between the fingertip 50 and the designated display region 40. Therefore, it is easy to select character information regardless of the size of the display surface 15 of the display 14.

The user can also select and determine the character information included in the character information group associated with the display region 40 by moving the fingertip 50 close to the designated display region 40 from the location of the fingertip 50 when the display region 40 is designated. In other words, character information can be input by moving the fingertip 50 in a diagonal direction or in a vertical direction with respect to the designated display region 40. Therefore, it is operable intuitively and easy to operate.

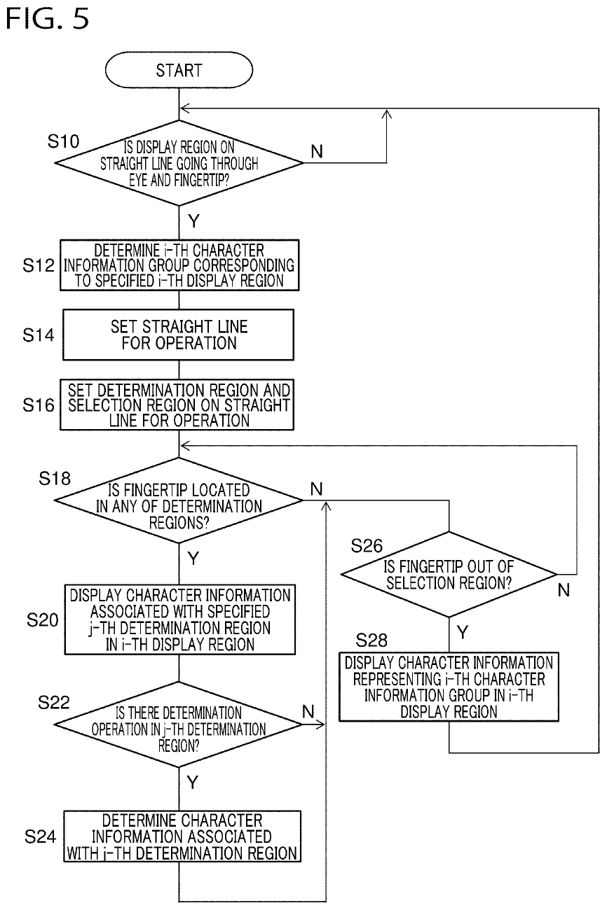

Next, the overall operation of the information processing system 1 having the configuration described above will be described. FIG. 5 is a flowchart showing a process of the information processing system 1 in FIG. 1. The determination unit 30 determines whether or not there is the display region 40 on the straight line L0 going through the eye 52 and the fingertip 50 (S10). In a case where no display region 40 is on the straight line L0 (N in S10), the determination unit 30 returns to the process in S10.

In a case where the display region 40 is on the straight line L0 (Y in S10), the determination unit 30 determines the i-th character information group corresponding to the specified i-th display region 40_i (S12). The setting unit 32 sets the straight line L1 for operation (S14) and sets the determination region 44 and the selection region R1 on the straight line L1 for operation (S16).

The determination unit 30 determines whether or not the fingertip 50 is located in any of the determination regions 44 (S18). In a case where the fingertip 50 is located in any of the determination regions 44 (Y in S18), the display output unit 36 displays the character information associated with the specified j-th determination region 44_j in the i-th display region 40_i (S20).

The determination unit 30 determines whether or not there is a determination operation in the j-th determination region 44_j (S22). In a case where there is a determination operation (Y in S22), the function execution unit 34 determines the character information associated with the j-th determination region 44_j (S24). The determination unit 30 determines whether or not the fingertip 50 is out of the selection region R1 (S26). In a case where the fingertip 50 is not out of the selection region R1 (N in S26), the determination unit 30 returns to the process in S18.

In a case where the fingertip 50 is out of the selection region R1 (Y in S26), the display output unit 36 displays the character information representing the i-th character information group in the i-th display region 40_i (S28), and the process of the information processing system 1 returns to the process in S10 performed by the determination unit 30.

In S18, in a case where the fingertip 50 is not located in any of the determination regions 44 (N in S18), the determination unit 30 proceeds to the process in S26. In S22, in a case where no determination operation is in the j-th determination region 44_j (N in S22), the determination unit 30 proceeds to the process in S26.

The determination unit 30 may determine whether or not the fingertip 50 has designated any of the plurality of the display regions 40 without using the location of the eye 52 of the user.

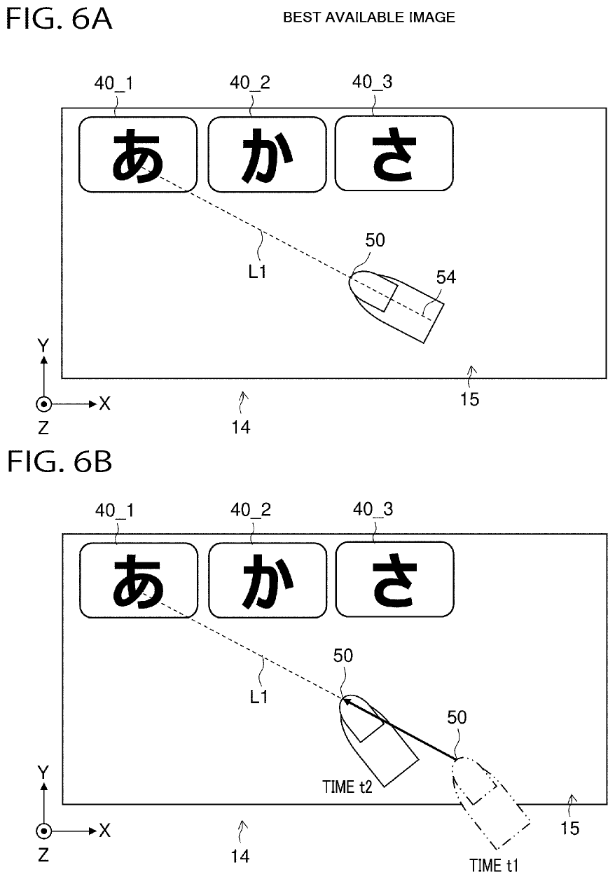

FIGS. 6A and 6B are plan views of the display 14 for describing another example of the operation of designating the display region 40 in the information processing system 1 in FIG. 1. In FIGS. 6A and 6B, the illustration of the input display region 42 is omitted. FIG. 6A is a diagram for describing the operation of designating the display region 40 according to the direction of the fingertip 50. The image reception unit 24 calculates the respective spatial coordinates in the time series of the fingertip 50 of the user and the predetermined location 54 of the finger. The predetermined location 54 of the finger is, for example, the first joint of the finger, the second joint of the finger, or the base of the finger. In a case where the display region 40 is on the straight line L1 going through the fingertip 50 and the predetermined location 54 of the finger, the determination unit 30 determines that the fingertip 50 has designated the display region 40 on the straight line L1. In the example in FIG. 6A, it is determined that the fingertip 50 has designated the first display region 40_1. The straight line L1 is also used as the straight line for operation.

FIG. 6B is a diagram showing the operation of designating the display region 40 according to the movement direction of the fingertip 50. In a case where the display region 40 is on the straight line L1 going through the spatial coordinates of the fingertip 50 at time t1 and the spatial coordinates of the fingertip 50 at time t2 subsequent to time t1, the determination unit 30 determines that the fingertip 50 has designated the display region 40 on the straight line L1. In the example in FIG. 6B, it is determined that the fingertip 50 has designated the first display region 40_1. The straight line L1 is also used as the straight line for operation. In these modifications, the user can designate the display region 40 with no consideration of the location of the eye 52.

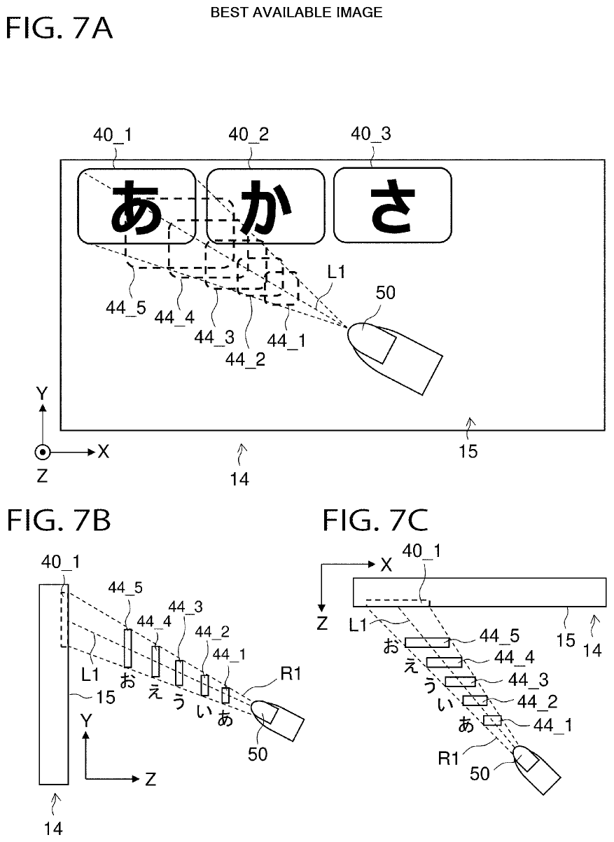

The sizes of a plurality of determination regions 44 may be different. FIGS. 7A to 7C show another example of the determination region 44 in the information processing system 1 in FIG. 1. FIG. 7A is a plan view of the display 14, FIG. 7B is a side view of the display 14, and FIG. 7C is a top view of the display 14.

The setting unit 32 sets the cross-sectional area of the determination region 44 in the cross-section parallel to the display surface 15 to be smaller as the location of the fingertip 50 at the reference time is closer. The cross-sectional area of the second determination region 44_2 in the cross-section parallel to the display surface 15 is larger than that of the first determination region 44_1 in the cross-section parallel to the display surface 15. The cross-sectional area of the third determination region 44_3 in the cross-section parallel to the display surface 15 is larger than that of the second determination region 44_2 in the cross-section parallel to the display surface 15. The cross-sectional area of the fourth determination region 44_4 in the cross-section parallel to the display surface 15 is larger than that of the third determination region 44_3 in the cross-section parallel to the display surface 15. The cross-sectional area of the fifth determination region 44_5 in the cross-section parallel to the display surface 15 is larger than that of the fourth determination region 44_4 in the cross-section parallel to the display surface 15.

In each of the determination regions 44, the cross-sectional area of the determination region 44 in the cross-section parallel to the display surface 15 is equal regardless of the location of the cross-section parallel to the display surface 15.

In addition, the volume of the second determination region 44_2 is larger than the volume of the first determination region 44_1. The volume of the third determination region 44_3 is larger than the volume of the second determination region 44_2. The volume of the fourth determination region 44_4 is larger than the volume of the third determination region 44_3. The volume of the fifth determination region 44_5 is larger than the volume of the fourth determination region 44_4.

This modification allows for greater flexibility in the setting of the determination region 44.

### Second Embodiment

In the second embodiment, the setting direction of the determination region 44 differs from that of the first embodiment. The following description focuses on the differences from the first embodiment.

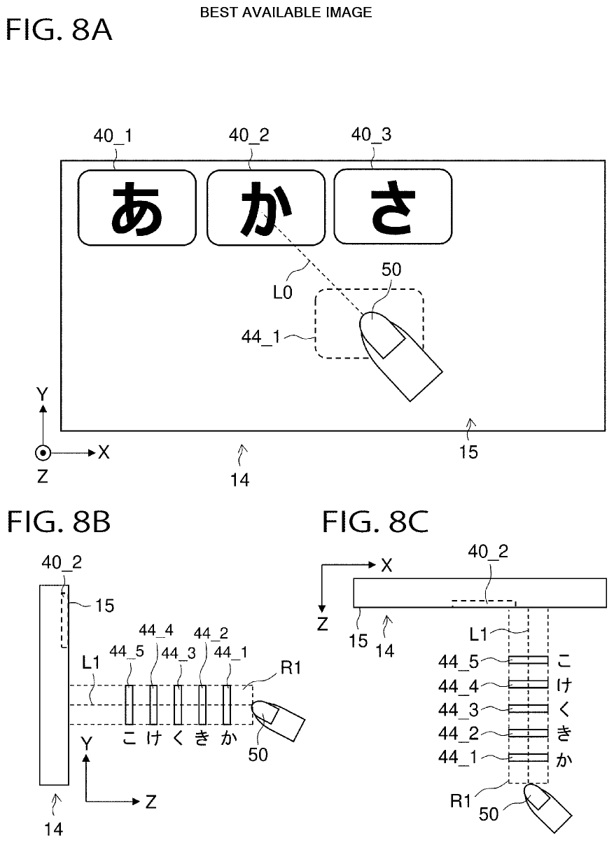

FIGS. 8A to 8C are diagrams for describing a character input operation in the information processing system 1 of the second embodiment. FIG. 8A is a plan view of the display 14, FIG. 8B is a side view of the display 14, and FIG. 8C is a top view of the display 14.

The setting unit 32 sets a plurality of determination regions 44 to intersect the straight line L1 that connects the spatial coordinates of the fingertip 50 at the reference time and the display surface 15, the straight line L1 being the normal line of the display surface 15. In other words, the straight line L1 is different from the straight line L0.

In the examples in FIGS. 8A to 8C, the fingertip 50 designates the second display region 40_2, and therefore, the setting unit 32 sets a plurality of determination regions 44 corresponding to the characters “ [symbol] ” reading “ka”, “ [symbol] ” reading “ki”, “ [symbol] ” reading “ku”, “ [symbol] ” reading “ke”, and “ [symbol] ” reading “ko” in the space between the fingertip 50 and the display surface 15.

According to the present embodiment, the user can select character information by moving the fingertip 50 in the normal line direction of the display surface 15 from the location of the fingertip 50 when the display region 40 is designated.

### Third Embodiment

In the third embodiment, the method for selecting and determining character information differs from that of the first embodiment. The following description focuses on the differences from the first embodiment.

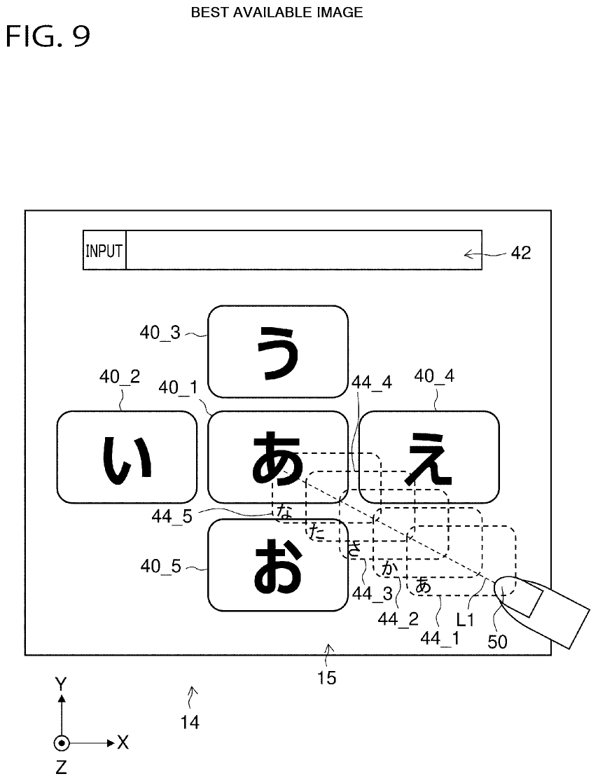

FIG. 9 is a plan view of the display 14 for describing a character input operation in the information processing system 1 of the third embodiment. The first character information group includes character information of the five characters “ [symbol] ” reading “a”, “ [symbol] ” reading “ka”, “ [symbol] ” reading “sa”, “ [symbol] ” reading “ta”, and “ [symbol] ” reading “na”. The second character information group includes character information of the five characters “ [symbol] ” reading “ha”, “ [symbol] ” reading “ma”, “ [symbol] ” reading “ya”, “ [symbol] ” reading “ra”, and “ [symbol] ” reading “wa”. Each character included in the first character information group is associated with a plurality of characters in the line of the character. In other words, the character “ [symbol] ” reading “a” is associated with other characters “ [symbol] ” reading “i”, “ [symbol] ” reading “u”, “ [symbol] ” reading “e”, and “ [symbol] ” reading “o” in the “ [symbol] ” reading “a” line. The character “ [symbol] ” reading “ka” is associated with other characters “ [symbol] ” reading “ki”, “ [symbol] ” reading “ku”, “ [symbol] ” reading “ke”, and “ [symbol] ” reading “ko” in the “ [symbol] ” reading “ka” line. The same applies to the character “ [symbol] ” reading “sa”, and others.

The first display region 40_1 is associated with the first character information group, and the character “ [symbol] ” reading “a” and representing the first character information group is displayed. As shown in FIG. 9, when the first display region 40_1 is designated with the fingertip 50, the setting unit 32 sets five determination regions 44 to intersect the straight line L1, and associates five characters of the first character information group with each of the five determination regions 44.

In FIG. 9, the first determination region 44_1 corresponds to the character “ [symbol] ” reading “a”, the second determination region 44_2 corresponds to the character “ [symbol] ” reading “ka”, the third determination region 44_3 corresponds to the character “ [symbol] ” reading “sa”, the fourth determination region 44_4 corresponds to the character “ [symbol] ” reading “ta”, and the fifth determination region 44_5 corresponds to the character “ [symbol] ” reading “na”.

Although illustrations are omitted, in the sixth display region within the display surface 15, the second character information group is associated, and the character “ [symbol] ” reading “ha” and representing the second character information group is displayed. When the sixth display region is designated with the fingertip 50, the setting unit 32 sets five determination regions 44 and associates five characters of the second character information group with each of the five determination regions 44.

After a plurality of determination regions 44 are set, the determination unit 30 determines whether or not the fingertip 50 is located in any of the determination regions 44.

In a case where the determination unit 30 determines that the fingertip 50 is located in the j-th determination region 44_j, the display output unit 36 displays character information associated with the j-th determination region 44_j in the first display region 40_1, and displays four pieces of character information, associated with the character information displayed in the first display region 40_1, in the second display region 40_2, the third display region 40_3, the fourth display region 40_4, and the fifth display region 40_5, respectively.

The second display region 40_2, the third display region 40_3, the fourth display region 40_4, and the fifth display region 40_5 are adjacent to the first display region 40_1, respectively. The second display region 40_2 is located on the left of the first display region 40_1. The third display region 40_3 is located above the first display region 40_1. The fourth display region 40_4 is located on the right of the first display region 40_1. The fifth display region 40_5 is located below the first display region 40_1.

In FIG. 9, the fingertip 50 is located in the first determination region 44_1, and therefore the character “ [symbol] ” reading “a” is displayed in the first display region 40_1, the character “ [symbol] ” reading “i” is displayed in the second display region 40_2, the character “ [symbol] ” reading “u” is displayed in the third display region 40_3, the character “ [symbol] ” reading “e” is displayed in the fourth display region 40_4, and the character “ [symbol] ” reading “o” is displayed in the fifth display region 40_5.

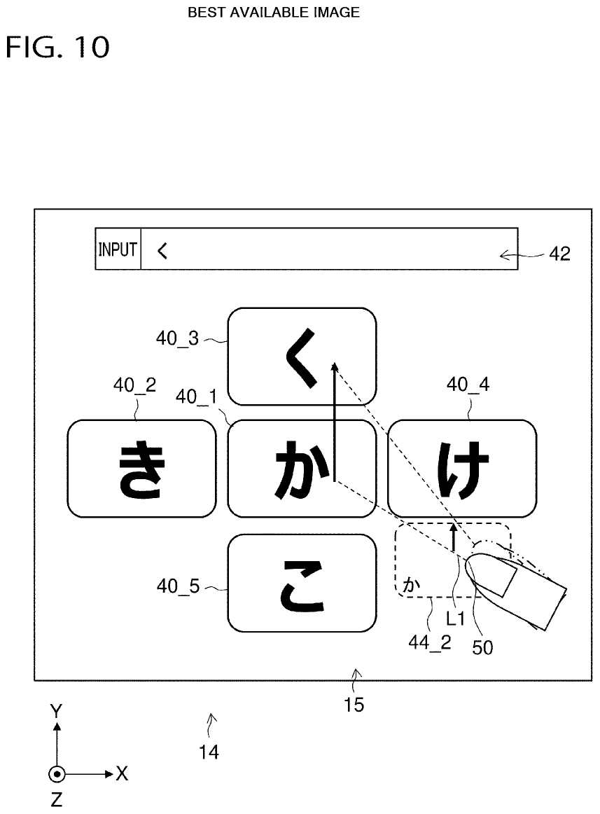

FIG. 10 is a plan view of the display 14 for describing a character input operation following FIG. 9. In FIG. 10, the determination regions 44 are omitted except the second determination region 44_2. In FIG. 10, the fingertip 50 is located in the second determination region 44_2, and therefore the character “ [symbol] ” reading “ka” is displayed in the first display region 40_1, the character “ [symbol] ” reading “ki” is displayed in the second display region 40_2, the character “ [symbol] ” reading “ku” is displayed in the third display region 40_3, the character “ [symbol] ” reading “ke” is displayed in the fourth display region 40_4, and the character “ [symbol] ” reading “ko” is displayed in the fifth display region 40_5.

Thus, relevant character information, which can be input, can be displayed in the surroundings of the selected character information by the operation of the fingertip 50.

The determination unit 30 determines whether or not the first determination operation or the second determination operation has been performed with the fingertip 50. In a case where the determination unit 30 determines that the fingertip 50 is located in the j-th determination region 44_j and the first determination operation has been performed, the display output unit 36 displays the character information associated with the j-th determination region 44_j in the input display region 42. In other words, character information in the first character information group can be input by the first determination operation. The first determination operation may be the same as the determination operation of the first embodiment.

In a case where the determination unit 30 determines that the fingertip 50 has designated any of the display regions 40 in the surroundings of the first display region 40_1 and that a second determination operation has been performed, the display output unit 36 displays the character information of the target of the second determination operation in the input display region 42. The second determination operation is a determination operation for character information in the display regions 40 in the surroundings of the first display region 40_1. For example, the second determination operation is an operation to move the fingertip 50 from the first display region 40_1 to any of display regions 40 in the surroundings at a speed equal to or greater than a predetermined speed. This operation can also be referred to as a flicking operation in the air.

The second determination operation may be the same as the first determination operation. In other words, the first determination operation may be performed in a state in which the surrounding display region 40 is designated with the fingertip 50.

In FIG. 10, a flick operation in the air is performed with the fingertip 50, and the fingertip 50 designates the third display region 40_3, and therefore the character “ [symbol] ” reading “ku” displayed in the third display region 40_3 is input.

Thus, character information can be input by a different character input operation from that of the first embodiment.

Note that the first character information group and the second character information group may be combined into a single character information group. In this case, when the first display region 40_1 is designated by fingertip 50, the setting unit 32 sets ten determination regions 44 and associates ten characters of the character information group with each of the ten determination regions 44.

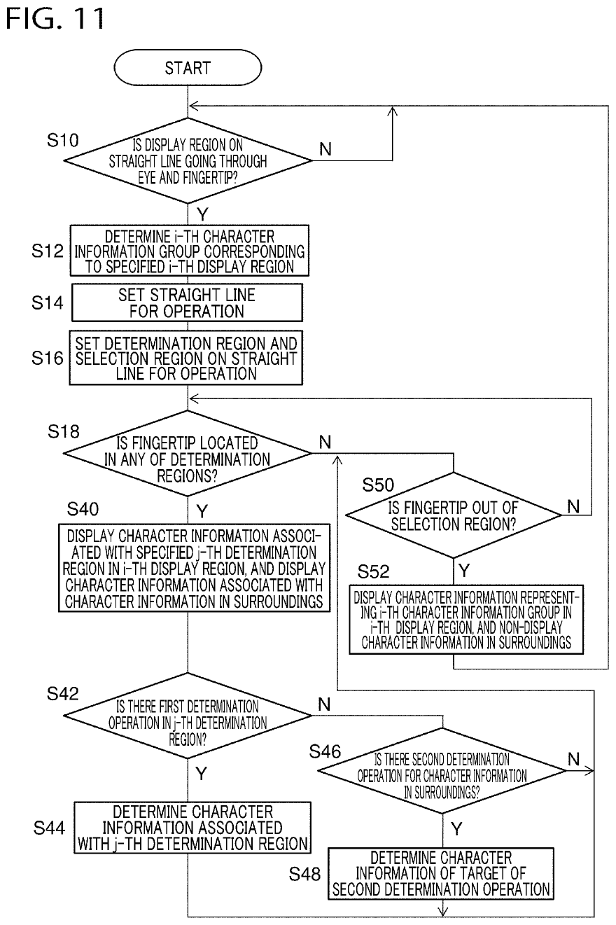

FIG. 11 is a flowchart showing the process of the information processing system 1 of the third embodiment. The process from S10 to S18 is the same as in the first embodiment in FIG. 5. In S18, in a case where the fingertip 50 is located in any of the determination regions 44 (Y in S18), the display output unit 36 displays character information associated with the specified j-th determination region 44_j in the i-th display region 40_i, and displays character information associated with the character information in the surroundings of the i-th display region 40_i (S40).

The determination unit 30 determines whether or not there is a first determination operation in the j-th determination region 44_j (S42). In a case where there is the first determination operation (Y in S42), the function execution unit 34 determines the character information associated with the j-th determination region 44_j (S44). The determination unit 30 determines whether or not the fingertip 50 is out of the selection region R1 (S50). The selection region R1 is set as in the first embodiment. In a case where the fingertip 50 is not out of the selection region R1 (N in S50), the determination unit 30 returns to the process in S18.

In a case where the fingertip 50 is out of the selection region R1 (Y in S50), the display output unit 36 displays the character information representing the i-th character information group in the i-th display region 40_i and non-displays the character information in the surroundings of the i-th display region 40_i (S52), and the process of the information processing system 1 returns to the process in S10 performed by the determination unit 30.

In S18, in a case where the fingertip 50 is not located in any of the determination regions 44 (N in S18), the determination unit 30 proceeds to the process in S50. In S42, in a case where no determination operation is in the j-th determination region 44_j (N in S42), the determination unit 30 determines whether or not there is a second determination operation for the character information in the surroundings of the i-th display region 40_i (S46). In a case where there is a second determination operation (Y in S46), the function execution unit 34 determines the character information of the target of the second determination operation (S48), and the process of the information processing system 1 returns to the process in S50 performed by the determination unit 30. In S46, in a case where there is no second determination operation (N in S46), the determination unit 30 proceeds to the process in S50.

### Fourth Embodiment

In the fourth embodiment, it is different from the first embodiment in that a character can be input by the character input operation of each of the five fingers. The following description focuses on the differences from the first embodiment.

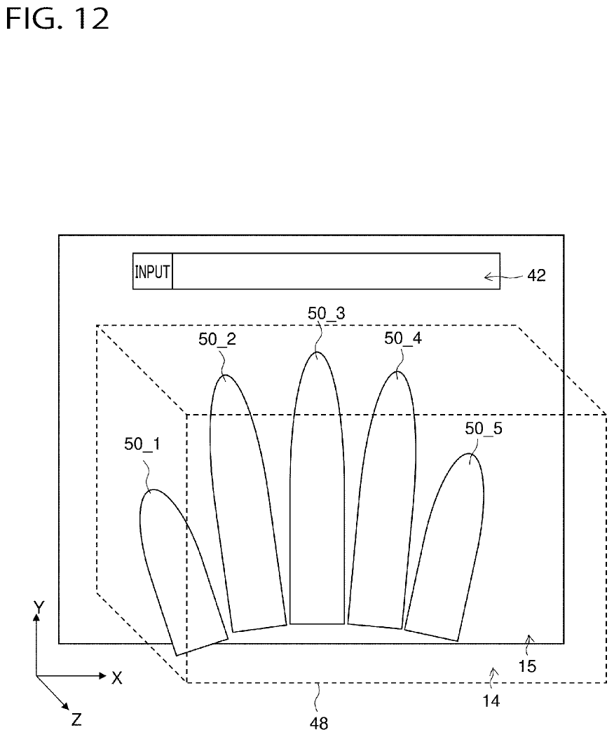

FIG. 12 is a perspective view of the display 14 for describing the character input operation in the information processing system 1 of the fourth embodiment. A predetermined input space 48 is set in front of the display surface 15 of the display 14. On starting to input characters, the user holds up five fingertips of one hand in front of the display surface 15 and places them in the input space 48.

The image reception unit 24 calculates the respective spatial coordinates of the first fingertip 50_1, the second fingertip 50_2, the third fingertip 50_3, the fourth fingertip 50_4, and the fifth fingertip 50_5 of the hand located in front of the display surface 15. For example, the first fingertip 50_1 is the thumb fingertip, the second fingertip 50_2 is the index finger fingertip, and the third fingertip 50_3 is the middle finger fingertip. The fourth fingertip 50_4 is the ring finger fingertip and the fifth fingertip 50_5 is the little finger fingertip. Hereafter, when the first fingertip 50_1 to the fifth fingertip 50_5 are not distinguished, they are referred to as the fingertip 50. The five fingertips 50 are an example of five detection objects used for control inputs, and the five detection objects are not limited to the five fingertips 50.

The determination unit 30 determines whether or not the five fingertips 50 have been placed in the input space 48 based on the spatial coordinates of each of the five fingertips 50. The placement of the five fingertips 50 into the input space 48 corresponds to the satisfaction of the predetermined input start condition. The determination unit 30 outputs the determination results to the display output unit 36. The determination unit 30 outputs to the setting unit 32 the determination results and the spatial coordinates of each of the five fingertips 50 at the reference time that is a time when the input start condition is satisfied.

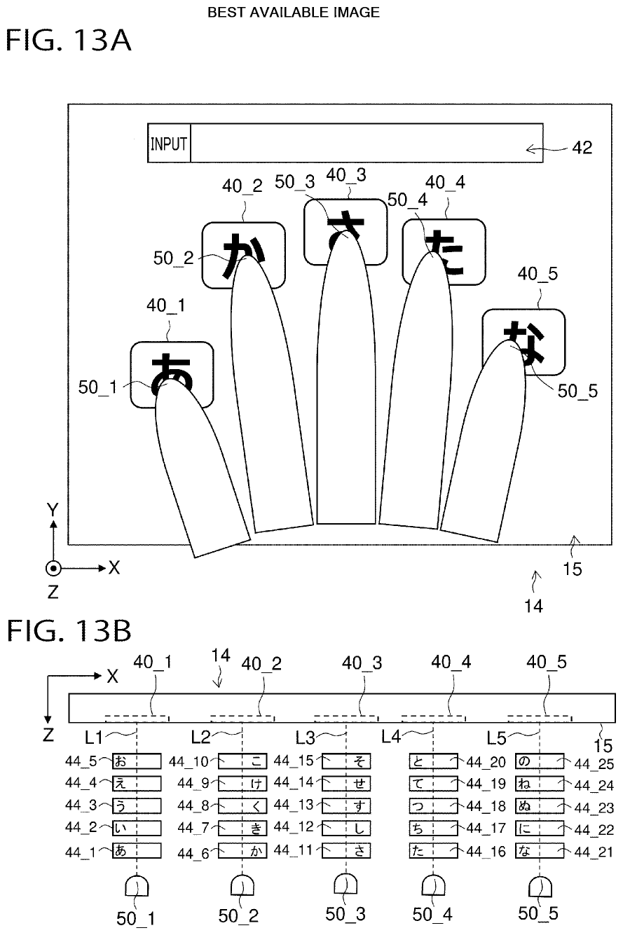

FIGS. 13A and 13B are diagrams for describing a character input operation following FIG. 12. FIG. 13A is a plan view of the display 14 and FIG. 13B is a top view of the display 14.

In a case where the determination unit 30 determines that the input start condition is satisfied, the display output unit 36 displays an image including the first display region 40_1, second display region 40_2, third display region 40_3, fourth display region 40_4, and fifth display region 40_5 on the display surface 15, based on the spatial coordinates at the reference time of each of the five fingertips 50. k is any integer from 1 to 5. For example, the k-th display region 40_k intersects a straight line that connects the spatial coordinates of the k-th fingertip 50_k at the reference time and the display surface 15, the straight line being the normal line of the display surface 15.

In the image in the initial state, the display output unit 36 displays the character information representing the k-th character information group, which is information on the k-th character information group, in the k-th display region 40_k.

As shown in FIG. 13A, from the user's perspective, the character “ [symbol] ” reading “a” is superimposed on the first fingertip 50_1, the character “ [symbol] ” reading “ka” is superimposed on the second fingertip 50_2, the character “ [symbol] ” reading “sa” is superimposed on the third fingertip 50_3, the character “ [symbol] ” reading “ta” is superimposed on the fourth fingertip 50_4, and the character “ [symbol] ” reading “na” is superimposed on the fifth fingertip 50_5. Thus, the user can easily figure out which fingertip 50 to move to input which line of characters.

The setting unit 32 sets a plurality of determination regions 44 between the k-th display region 40_k and the k-th fingertip 50_k based on the coordinates of the k-th display region 40_k and the spatial coordinates of the k-th fingertip 50_k at the reference time.

The setting unit 32 sets the k-th straight line Lk for operation that connects the spatial coordinates of the k-th fingertip 50_k at the reference time and the k-th display region 40_k, and sets five determination regions 44 to intersect the k-th straight line Lk.

The setting unit 32 associates twenty-five pieces of character information included in the first character information group to the fifth character information group with twenty-five determination regions 44 on a one-to-one basis.

As shown in FIG. 13B, the first determination region 44_1 to the fifth determination region 44_5 intersect the first straight line L1. The sixth determination region 44_6 to the tenth determination region 44_10 intersect the second straight line L2. The eleventh determination region 44_11 to the fifteenth determination region 44_15 intersect the third straight line L3. The sixteenth determination region 44_16 to the twentieth determination region 44_20 intersect the fourth straight line L4. The twenty-first determination region 44_21 to the twenty-fifth determination region 44_25 intersect the fifth straight line L5.

After the plurality of determination regions 44 have been set, the determination unit 30 determines whether or not the first fingertip 50_1 is located in any of the first determination region 44_1 to the fifth determination region 44_5, and whether or not the second fingertip 50_2 is located in any of the sixth determination region 44_6 to the tenth determination region 44_10. After the plurality of determination regions 44 have been set, the determination unit 30 determines whether or not the third fingertip 50_3 is located in any of the eleventh determination region 44_11 to the fifteenth determination region 44_15, whether or not the fourth fingertip 50_4 is located in any of the sixteenth determination region 44_16 to the twentieth determination region 44_20, and whether or not the fifth fingertip 50_5 is located in any of the twenty-first determination region 44_21 to the twenty-fifth determination region 44_25.

m is any integer from 1 to 5. In a case where the determination unit 30 determines that the m-th fingertip 50_m is located in the j-th determination region 44_j, the display output unit 36 displays the character information associated with the j-th determination region 44_j in the m-th display region 40_m.

The determination unit 30 determines whether or not a determination operation has been performed by the m-th fingertip 50_m in the j-th determination region 44_j.

In a case where the determination unit 30 determines that the m-th fingertip 50_m is located in the j-th determination region 44_j and the determination operation has been performed, the function execution unit 34 determines character information associated with the j-th determination region 44_j and accepts an input of the character information.

In a case where the determination unit 30 determines that the m-th fingertip 50_m is located in the j-th determination region 44_j and that a determination operation has been performed, the display output unit 36 displays the character information associated with the j-th determination region 44_j in the input display region 42.

The user can input the selected character by moving the fingertip 50 on the display region 40 corresponding to the line to which the character to be input belongs close to the display region 40, selecting the character to be input, and performing a determination operation with the fingertip 50.

The determination unit 30 also determines whether or not a predetermined character switching operation is performed in the input space 48 by at least one fingertip 50. In a case where the determination unit 30 determines that the character switching operation has been performed, the display output unit 36 displays the information on the (k+5)-th character information group in the k-th display region 40_k in the image in the initial state. The display surface 15 shows the characters “ [symbol] ” reading “ha”, “ [symbol] ” reading “na”, “ [symbol] ” reading “ya”, “ [symbol] ” reading “ra”, and “ [symbol] ” reading “wa”.

In a case where the determination unit 30 determines that the character switching operation has been performed, the setting unit 32 associates the plurality of character information included in the sixth character information group to the tenth character information group with the plurality of determination regions 44 on a one-to-one basis.

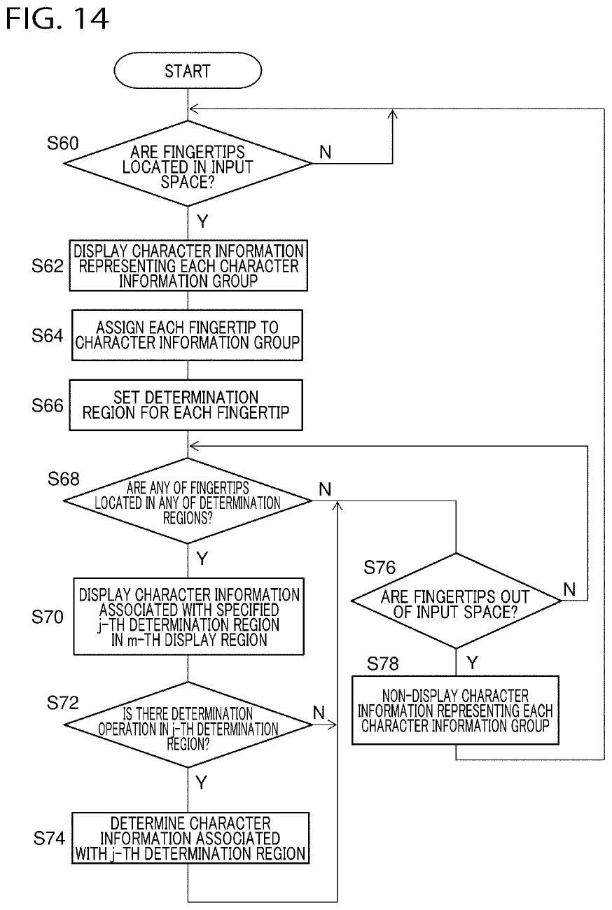

FIG. 14 is a flowchart showing the process of the information processing system 1 of a fourth embodiment. The determination unit 30 determines whether or not five fingertips 50 are located in the input space 48 (S60). In a case where the five fingertips 50 are not located in the input space 48 (N in S60), the determination unit 30 returns to the process in S60.

In a case where the five fingertips 50 are located in the input space 48 (Y in S60), the display output unit 36 displays character information representing each character information group (S62). The setting unit 32 assigns each fingertip 50 to a character information group (S64) and sets the determination region 44 for each fingertip 50 (S66).

The determination unit 30 determines whether or not any of the fingertips 50 are located in any of the determination regions 44 (S68). In a case where this condition is satisfied (Y in S68), the display output unit 36 displays the character information associated with the specified j-th determination region 44_j in the m-th display region 40_m (S70).

The determination unit 30 determines whether or not there is a determination operation in the j-th determination region 44_j (S72). In a case where there is a determination operation (Y in S72), the function execution unit 34 determines the character information associated with the j-th determination region 44_j (S74). The determination unit 30 determines whether or not the five fingertips 50 are out of the input space 48 (S76). In a case where the five fingertips 50 are not out of the input space 48 (N in S76), the determination unit 30 returns to the process in S68.

In a case where the five fingertips 50 are out of the input space 48 (Y in S76), the display output unit 36 non-displays the character information representing each character information group (S78), and the process of the information processing system 1 returns to the process in S60 performed by the determination unit 30.

In S68, in a case where any of the fingertips 50 is not located in any of the determination regions 44 (N in S68), the determination unit 30 proceeds to the process in S76. In S72, in a case where no determination operation is in the j-th determination region 44_j (N in S72), the determination unit 30 proceeds to the process in S76.

According to the present embodiment, character information can be input using five fingers.

Note that a plurality of display regions 40 may be displayed at a predetermined location on the display surface 15, regardless of the spatial coordinates of each of the five fingertips 50 at the reference time.

Also, as in the second embodiment, for each of the fingertips 50, a plurality of determination regions 44 may be set along the normal line of the display surface 15. In other words, the setting unit 32 may set five determination regions 44 to intersect the k-th straight line Lk, which is the normal line of the display surface 15, the k-th straight line Lk for operation connecting the spatial coordinates of the k-th fingertip 50_k at the reference time and the display surface 15. The user can select character information by moving each of the fingertips 50 in the normal line direction of the display surface 15.

### Fifth Embodiment

In the fifth embodiment, it is different from the first embodiment in that a word starting with the input character can be selected and input. The following description focuses on the differences from the first embodiment.

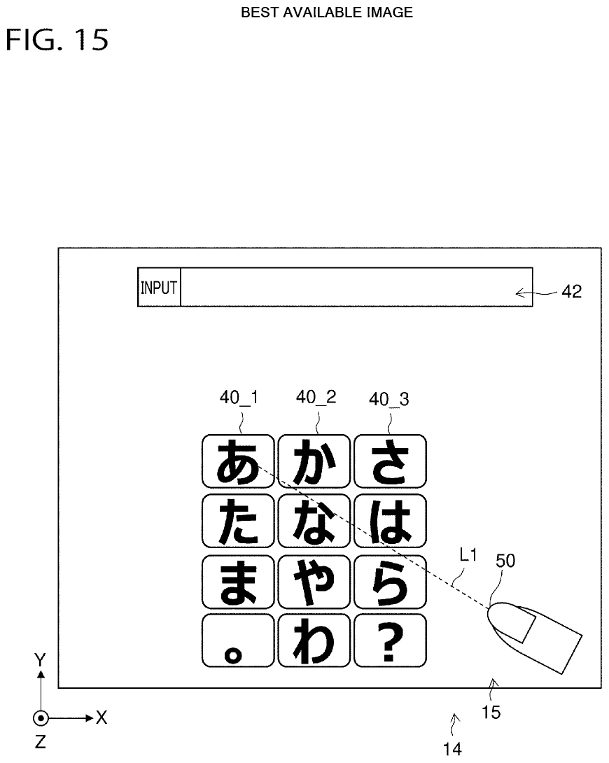

FIG. 15 is a plan view of the display 14 for describing the character input operation in the information processing system 1 of the fifth embodiment. First, the user performs a character input operation with the fingertip 50 as in the first embodiment. Here, it is assumed that the character “ [symbol] ” reading “a” is input.

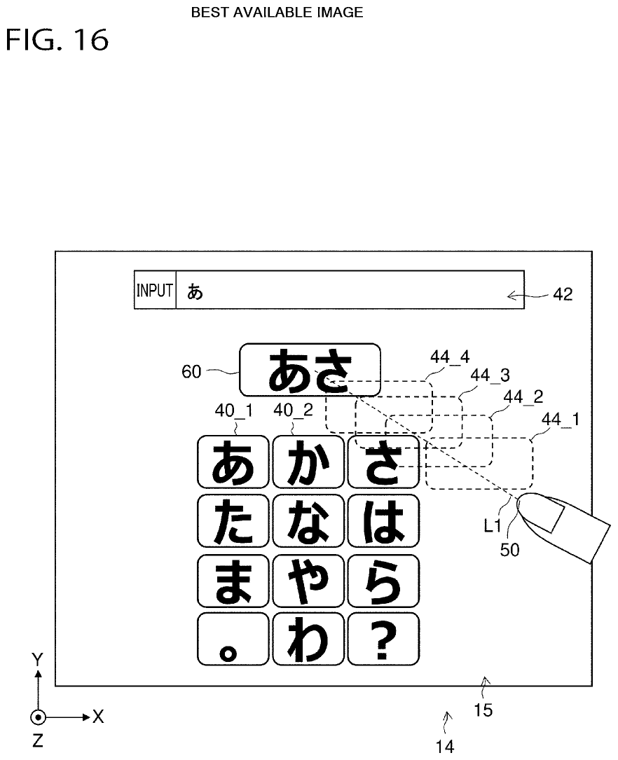

FIG. 16 is a plan view of the display 14 for describing a character input operation following FIG. 15. The storage unit 22 stores a plurality of pieces of word information. In a case where the function execution unit 34 accepts an input of character information, the function execution unit 34 selects a word starting with the accepted character from the word information held in the storage unit 22, and generates image data for displaying the selected word in the display region 60 of the word. For example, as shown in FIG. 15, the word “ [symbol] ” reading “asa” is displayed in the display region 60 of the word.

In a case where the user wants to input a word, the user designates the display region 60 of the word with the fingertip 50. In a case where the determination unit 30 determines that the fingertip 50 has designated the display region 60 of the word, the setting unit 32 sets a plurality of determination regions 44 of the word between the display region 60 of the word and the fingertip 50, based on the coordinates of the display region 60 of the word and the spatial coordinates of the fingertip 50 at the reference time supplied from the determination unit 30.

The setting unit 32 selects a plurality of words starting with the accepted character from the word information held in the storage unit 22, and associates the selected plurality of words with the plurality of determination regions 44 on a one-to-one basis. The selected plurality of words constitutes a character information group.

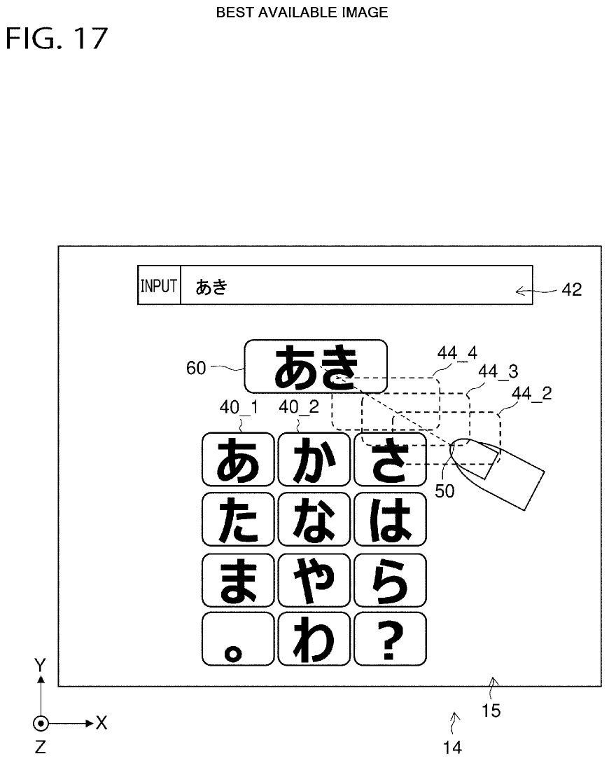

FIG. 17 is a plan view of the display 14 for describing a character input operation following FIG. 16. The user moves the fingertip 50 close to the display region 60 of the word, and the fingertip 50 is in the second determination region 44_2. The word “ [symbol] ” reading “aki” is associated with the second determination region 44_2.

In a case where the determination unit 30 determines that the fingertip 50 is located in the j-th determination region 44_j, the display output unit 36 displays the word associated with the j-th determination region 44_j in the display region 60 of the word. The word “ [symbol] ” reading “aki” is displayed in the display region 60 of the word instead of the word “ [symbol] ” reading “asa”.

The user performs a determination operation with the fingertip 50 when the word “ [symbol] ” reading “aki” to be input is displayed in the display region 60 of the word, that is, when the fingertip 50 is located in the second determination region 44_2. In response, the function execution unit 34 accepts an input of the word “ [symbol] ” reading “aki”, which is the character information associated with the second determination region 44_2, and the display output unit 36 displays the word “ [symbol] ” reading “aki” in the input display region 42. According to the present embodiment, a word can be input.

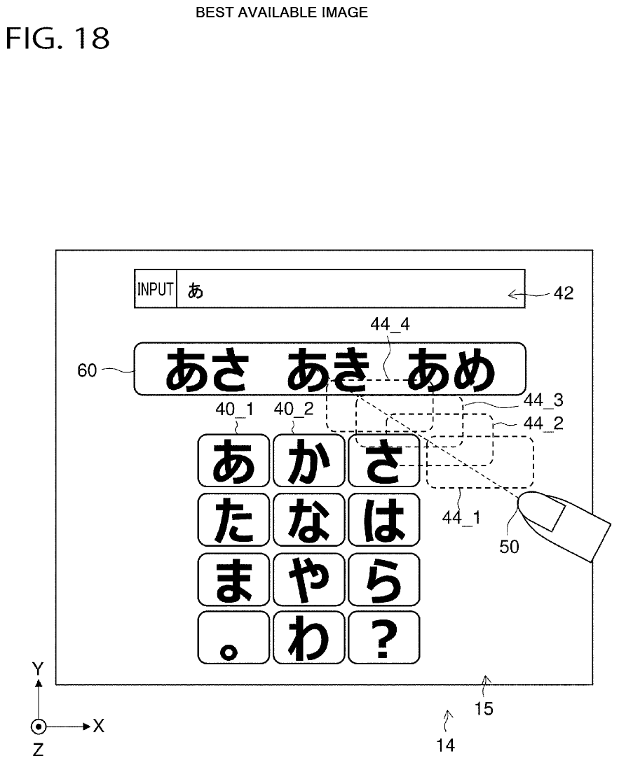

A plurality of words may be displayed in the display region 60 of the word. FIG. 18 is a plan view of the display 14 for describing another example of character input operation in the information processing system 1 of the fifth embodiment.

In a case where the function execution unit 34 accepts input of character information, the function execution unit 34 selects a plurality of words starting with the accepted character from the word information held in the storage unit 22, and generates image data for displaying the selected plurality of words in the display region 60 of the word. For example, as shown in FIG. 18, the three words “ [symbol] [symbol] ” reading “asa”, “ [symbol] ” reading “aki”, and “ [symbol] ” reading “ame” are displayed in the display region 60 of the word.

In a case where the determination unit 30 determines that the fingertip 50 has designated the display region 60 of the word, the setting unit 32 sets a plurality of determination regions 44 of the word between the display region 60 of the word and the fingertip 50.

The setting unit 32 selects a plurality of words starting with the accepted character from the word information held in the storage unit 22, and associates the selected plurality of words with the plurality of determination regions 44 on a many-to-one basis. For example, the setting unit 32 associates three words with one determination region 44. The selected plurality of words constitutes a character information group. The plurality of pieces of character information included in the character information group each includes a plurality of words starting with a predetermined character.

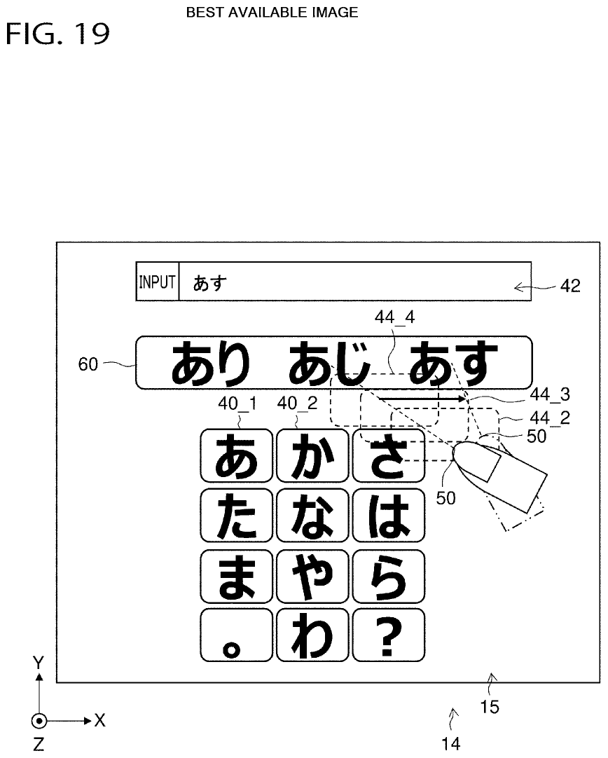

FIG. 19 is a plan view of the display 14 for describing a character input operation following FIG. 18. The user moves the fingertip 50 close to the display region 60 of the word, and the fingertip 50 is in the second determination region 44_2. Three words “ [symbol] ” reading “ari”, “ [symbol] ” reading “aji”, and “> [symbol] ” reading “asu” are associated with the second determination region 44_2 as character information.

In a case where the determination unit 30 determines that the fingertip 50 is located in the j-th determination region 44_j, the display output unit 36 displays the plurality of words associated with the j-th determination region 44_j in the display region 60 of the word. The display region 60 of the word displays three words “ [symbol] ” reading “ari”, “ [symbol] ” reading “aji”, and “ [symbol] ” reading “asu” instead of three words “ [symbol] ” reading “asa”, “ [symbol] ” reading “aki”, and “ [symbol] ” reading “ame”.

The user performs a determination operation for the word to be input with the fingertip 50 when the word “ [symbol] [symbol] ” reading “asu” to be input is displayed in the display region 60 of the word, that is, when the fingertip 50 is located in the second determination region 44_2. The determination operation for the word to be input is, for example, to point the fingertip 50 at the word displayed in the display region 60 of the word and perform the determination operation of the first embodiment. In response, the function execution unit 34 accepts an input of the word “ [symbol] ” reading “asu”, which is the character information of the target of the determination operation, and the display output unit 36 displays the word “ [symbol] ” reading “asu” in the input display region 42. In this example, a plurality of words are displayed, making it easy to select a word.

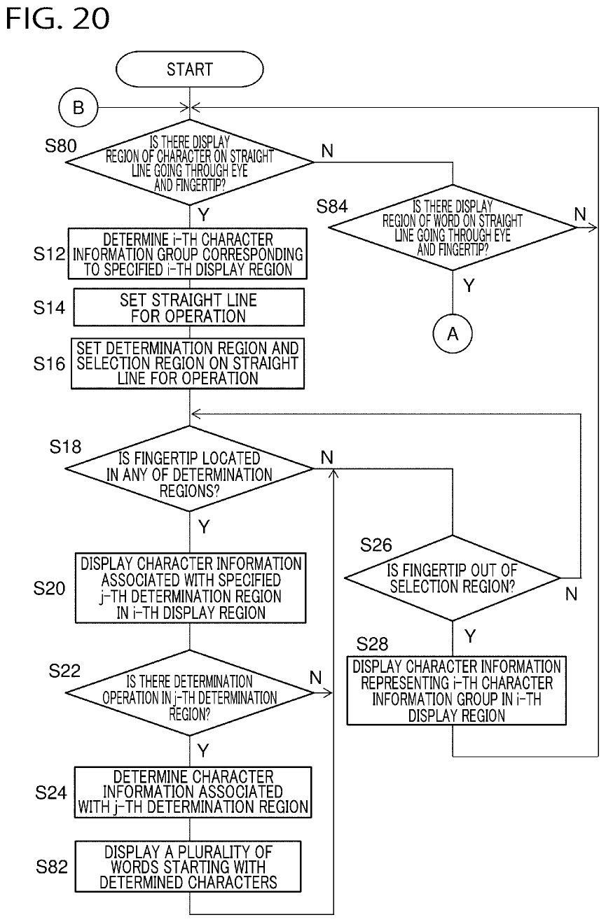

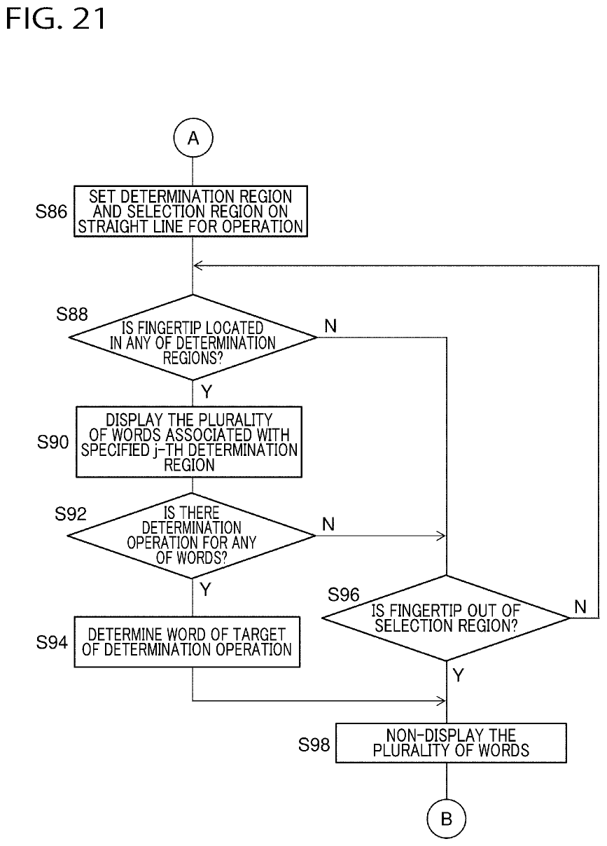

FIG. 20 is a flowchart showing the process of the information processing system 1 of the fifth embodiment. FIG. 21 is a flowchart following FIG. 20. The determination unit 30 determines whether or not there is the display region 40 of the character on the straight line going through the eye 52 and the fingertip 50 (S80). In a case where the display region 40 of the character is on the straight line (Y in S80), the determination unit 30 proceeds to the process in S12. The process from S12 to S24 is the same as in the first embodiment in FIG. 5. After S24, the display output unit 36 displays a plurality of words starting with the determined characters (S82), and the determination unit 30 proceeds to the process of S26. The process of S26 and S28 is the same as in the first embodiment in FIG. 5.

In S80, in a case where no display region 40 of the character is on the straight line going through the eye 52 and the fingertip 50 (N in S80), the determination unit 30 determines whether or not there is the display region 60 of the word on the straight line going through the eye 52 and the fingertip 50 (S84). In a case where no display region 60 of the word is on the straight line (N in S84), the determination unit 30 returns to the process in S10. In a case where the display region 60 of the word is on the straight line (Y in S84), the setting unit 32 sets the determination region 44 and the selection region R1 on the straight line L1 for the operation (S86).

The determination unit 30 determines whether or not the fingertip 50 is located in any of the determination regions 44 (S88). In a case where the fingertip 50 is located in any of the determination regions 44 (Y in S88), the display output unit 36 displays the plurality of words associated with the specified j-th determination region 44_j in the display region 60 of the word (S90).

The determination unit 30 determines whether or not there is a determination operation for any of the words (S92). In a case where there is a determination operation (Y in S92), the function execution unit 34 determines the word of the target of the determination operation (S94). The display output unit 36 non-displays the plurality of words (S98), and the process of the information processing system 1 returns to the process of S80 performed by the determination unit 30.

In S88, in a case where the fingertip 50 is not located in any of the determination regions 44 (N in S88), or in S92, in a case where there is no determination operation (N in S92), the determination unit 30 determines whether or not the fingertip 50 is out of the selection region R1 (S96). In a case where the fingertip 50 is not out of the selection region R1 (N in S96), the determination unit 30 proceeds to the process in S88. In a case where the fingertip 50 is out of the selection region R1 (Y in S96), the display output unit 36 executes the process in S98.

### Sixth Embodiment

In the sixth embodiment, it is different from the first embodiment in that an input of alphabetical or numerical characters can be accepted. The following description focuses on the differences from the first embodiment.

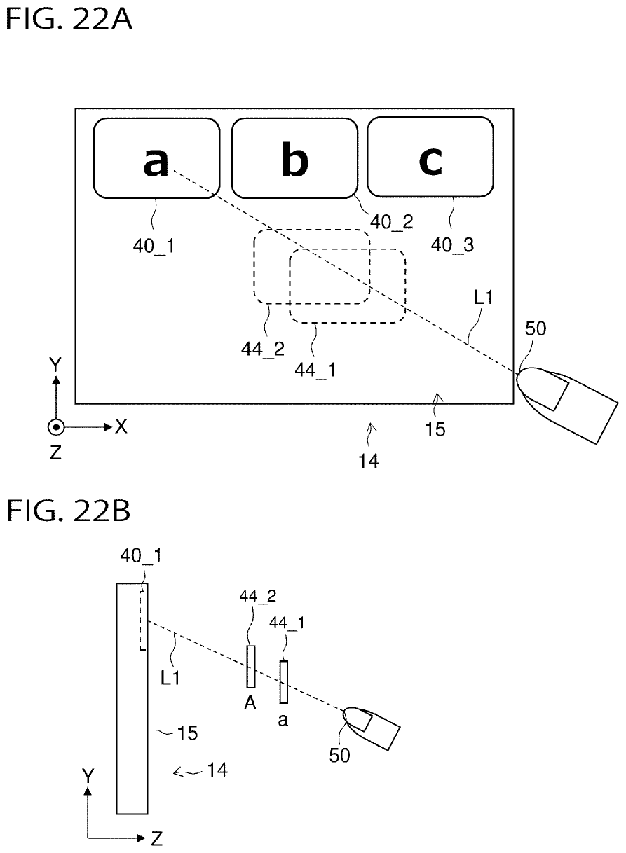

FIGS. 22A and 22B are diagrams for describing a first example of the character input operation in the information processing system of the sixth embodiment. FIG. 22A is a plan view of the display 14 and FIG. 22B is a side view of the display 14.

The control apparatus 12 accepts an input of an English alphabet. A plurality of character information groups include different kinds of alphabets. Each character information group includes upper case characters and lower case characters of the same alphabet.

The first character information group associated with the first display region 40_1 includes the characters “a” and “A”. The second character information group associated with the second display region 40_2 includes the characters “b” and “B”. The third character information group associated with the third display region 40_3 includes the characters “c” and “C”. The same applies to other character information groups associated with each of the other plurality of display regions 40, which are not shown.

The following is an example of a user inputting the character “A”. As shown in FIG. 22A, the user first designates the first display region 40_1, in which the character “a” is displayed, with the fingertip 50. The setting unit 32 sets the first determination region 44_1 associated with the character “a” and the second determination region 44_2 associated with the character “A”.

Next, the user moves the fingertip 50 close to the first display region 40_1 until the character “a” displayed in the first display region 40_1 changes to the character “A”. In a case where the fingertip 50 enters the second determination region 44_2 and the character “A” is displayed in the first display region 40_1, the user performs a determination operation with the fingertip 50. As a result, the character “A” is displayed in the input display region not shown in the diagram and is input to the control apparatus 12. The user can input a plurality of characters by repeating these operations.

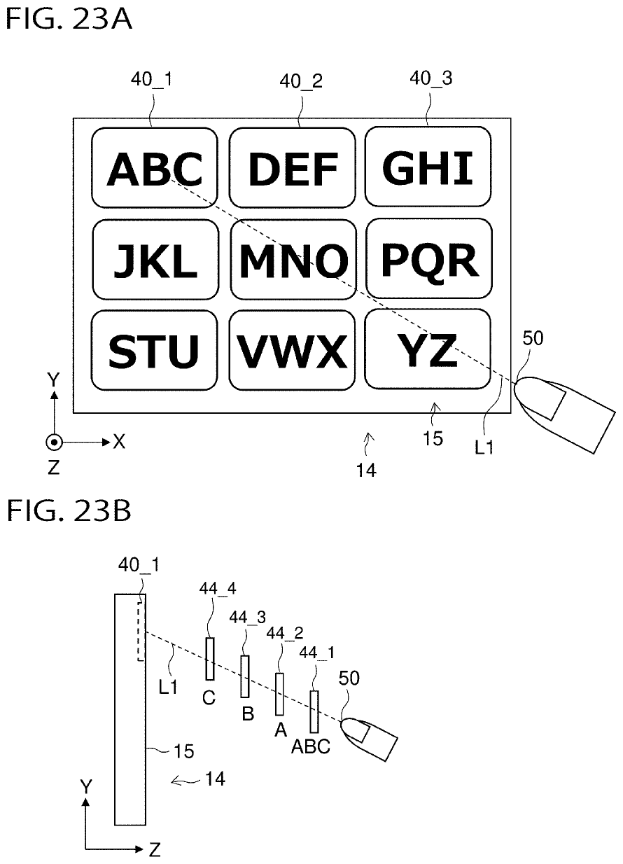

FIGS. 23A and 23B are diagrams for describing a second example of the character input operation in the information processing system of the sixth embodiment. FIG. 23A is a plan view of the display 14 and FIG. 23B is a side view of the display 14.

Each of the plurality of character information groups includes a plurality of upper case characters of alphabets. The first character information group associated with the first display region 40_1 includes the characters “A”, “B”, and “C”. The second character information group associated with the second display region 40_2 includes the characters “D”, “E”, and “F”. The third character information group associated with the third display region 40_3 includes the characters “G”, “H”, and “I”. The same applies to the characters included in other character information groups associated with each of the other plurality of display regions 40, as shown in FIG. 23A, the description of which is omitted.

In the image in the initial state, the first display region 40_1 displays a plurality of characters “ABC” included in the first character information group. The second display region 40_2 displays a plurality of characters “DEF” included in the second character information group. The third display region 40_3 displays a plurality of characters “GHI” included in the third character information group. A plurality of characters included in the associated character information group are also displayed in each of the other plurality of display regions 40, as shown in FIG. 23A, the description of which is omitted. This allows the user to easily figure out which characters are available for selection in which display region 40.

The following is an example of a user inputting the character “A”. As shown in FIG. 23A, the user first designates the first display region 40_1, in which the characters “ABC” are displayed, with the fingertip 50. The setting unit 32 sets the first determination region 44_1 associated with a plurality of characters “ABC”, the second determination region 44_2 associated with the character “A”, the third determination region 44_3 associated with the character “B”, and the fourth determination region 44_4 associated with the character “C”.

Next, the user moves the fingertip 50 close to the first display region 40_1 until the character “ABC” displayed in the first display region 40_1 changes to the character “A”. In a case where the fingertip 50 enters the second determination region 44_2 and the display in the first display region 40_1 changes to the character “A”, the user performs a determination operation with the fingertip 50. As a result, the character “A” is displayed in the input display region not shown in the diagram and is input to the control apparatus 12. The user can input a plurality of characters by repeating these operations.

Note that in a case where the fingertip 50 is located in the first determination region 44_1 associated with a plurality of characters “ABC”, the characters “ABC” are displayed in the first display region 40_1. In a case where a determination operation is performed in a state where the fingertip 50 is located in the first determination region 44_1, the character may not be input to the control apparatus 12, or the characters “ABC” may be input.

In the first example of character input operation in FIGS. 22A and 22B and the second example of character input operation in FIGS. 23A and 23B, as in the fifth embodiment, it may be configured to allow selection and input of a word starting with the input character. The basic character input operation and process is the same as in the fifth embodiment. For example, in a case where the character “C” is first input, one or a plurality of words starting with the character “C” are displayed in the display region of the word, and the displayed word can be selected and input in response to an operation with the fingertip 50.

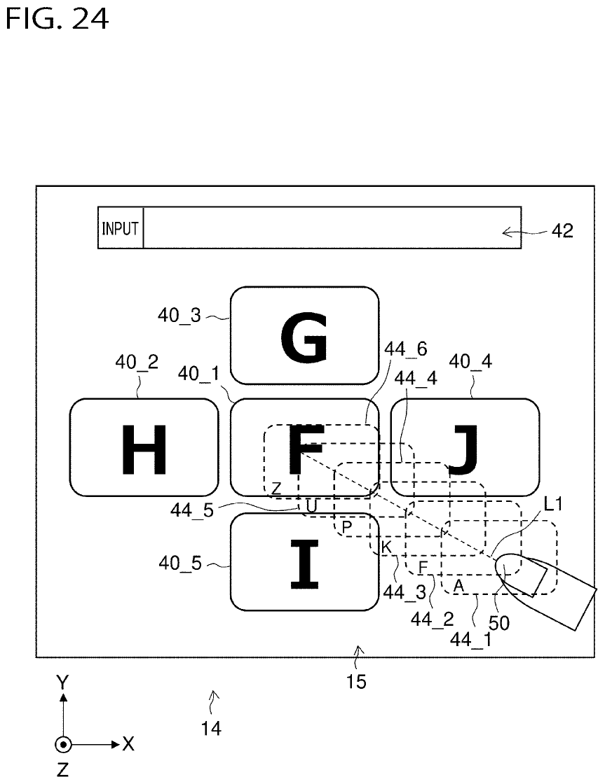

FIG. 24 is a plan view of the display 14 for describing a third example of character input operation in the information processing system 1 of the sixth embodiment. The basic character input operation and process is the same as in the third embodiment.

The character information group includes character information of six characters “A”, “F”, “K”, “P”, “U”, and “Z”. Each character in the character information group is associated with four characters that follow this character in alphabetical order. In other words, the character “A” is associated with four characters “B”, “C”, “D”, and “E” that follow “A”. The character “F” is associated with four letters “G”, “H”, “I”, and “J” that follow “F”. The same applies to the character “K”, and others.

The first display region 40_1 is associated with the above character information group, and in the initial state, the character “A” representing the character information group is displayed. When the first display region 40_1 is designated with the fingertip 50, the setting unit 32 sets six determination regions 44 and associates six characters of the character information group to the six determination regions 44. As shown in FIG. 24, for example, when the second display region 40_2 is designated with the fingertip 50, the character “F” is displayed in the first display region 40_1, and the characters “G,” “H,” “I,” and “J” are displayed in the surroundings of the character “F”. The same character input operation as in the third embodiment can be used to input alphabets.

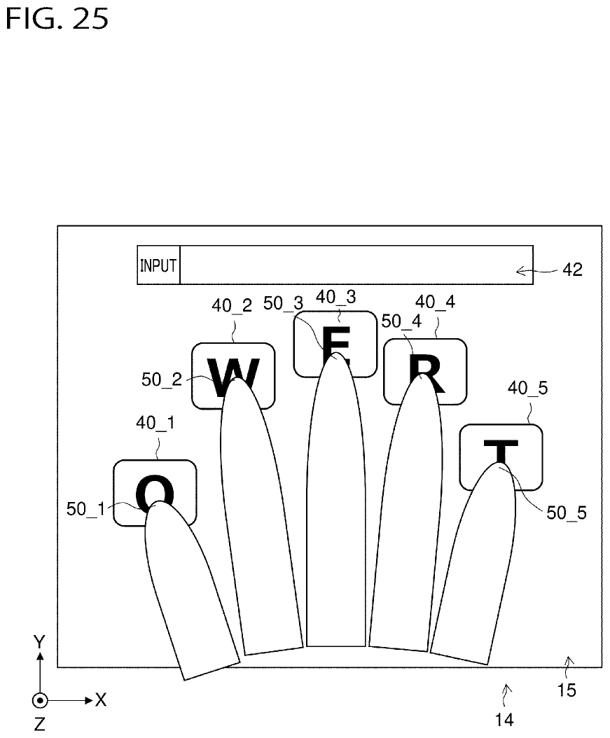

FIG. 25 is a plan view of a display 14 for describing a fourth example of character input operation in the information processing system 1 of the sixth embodiment. The basic character input operation and process is the same as in the fourth embodiment. In this example, a keyboard having a QWERTY array is simulated. From the user's perspective, the character “Q” is superimposed on the first fingertip 50_1, the character “W” is superimposed on the second fingertip 50_2, the character “E” is superimposed on the third fingertip 50_3, the character “R” is superimposed on the fourth fingertip 50_4, and the character “T” is superimposed on the fifth fingertip 50_5.

The setting unit 32 sets, for example, three determination regions 44 between the k-th display region 40_k and the k-th fingertip 50_k. Although not shown, between the first display region 40_1 and the first fingertip 50_1, for example, the first determination region 44_1 corresponding to the letter “Q”, the second determination region 44_2 corresponding to the letter “A”, and the third determination region 44_3 corresponding to the letter “Z” are set. Between the second display region 40_2 and the second fingertip 50_2, for example, the fourth determination region 44_4 corresponding to the character “W”, the fifth determination region 44_5 corresponding to the character “S”, and the sixth determination region 44_6 corresponding to the character “X” are set.

The user can input the selected character by moving the fingertip 50 on the display region 40 corresponding to the character to be input close to the display region 40, selecting the character to be input, and performing a determination operation with the fingertip 50.

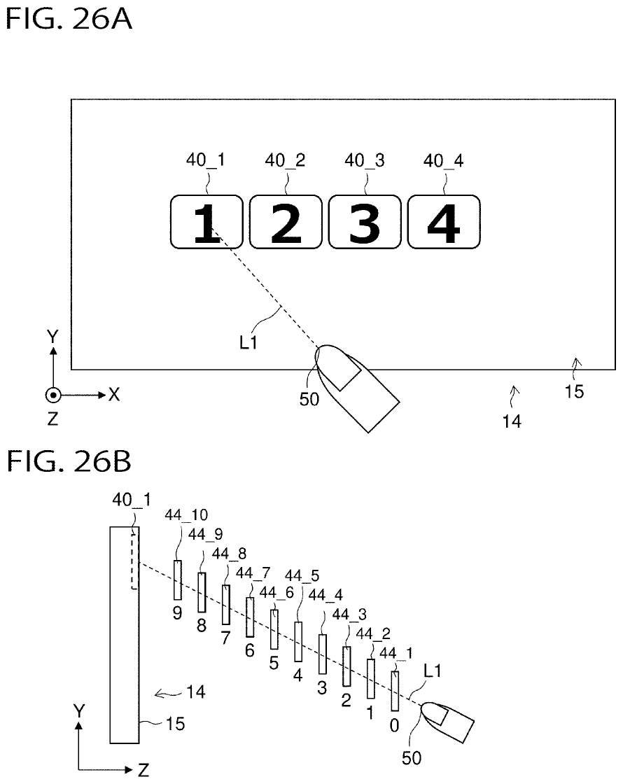

FIGS. 26A and 26B show a fifth example of character input operation in the information processing system 1 of the sixth embodiment. FIG. 26A is a plan view of the display 14 and FIG. 26B is a side view of the display 14.

The control apparatus 12 accepts an input of numbers. In FIG. 26A, the display surface 15 displays a screen for inputting a four-character password, for example. Each of the four display regions 40 functions as an input display region that displays the input numbers.

Each of the four display regions 40 is associated with the same character information group. The character information group includes information on a plurality of numbers. For example, a character information group includes information on integers from 0 to 9.

The user designates the first display region 40_1, for example, with the fingertip 50 without touching the display 14. The setting unit 32 sets the first determination region 44_1 associated with the number “0”, the second determination region 44_2 associated with the number “1”, the third determination region 44_3 associated with the number “2”, and so on.

Next, the user moves the fingertip 50 close to the first display region 40_1 until the number displayed in the first display region 40_1 changes to the number to be input. In a case where the number to be input is displayed in the first display region 40_1, the user performs a determination operation with the fingertip 50. In this way, the number to be input is input into the control apparatus 12. The user can input four numbers by performing these operations in each of four display regions 40.

### Various Examples of Determination Region 44 in First to Sixth Embodiments

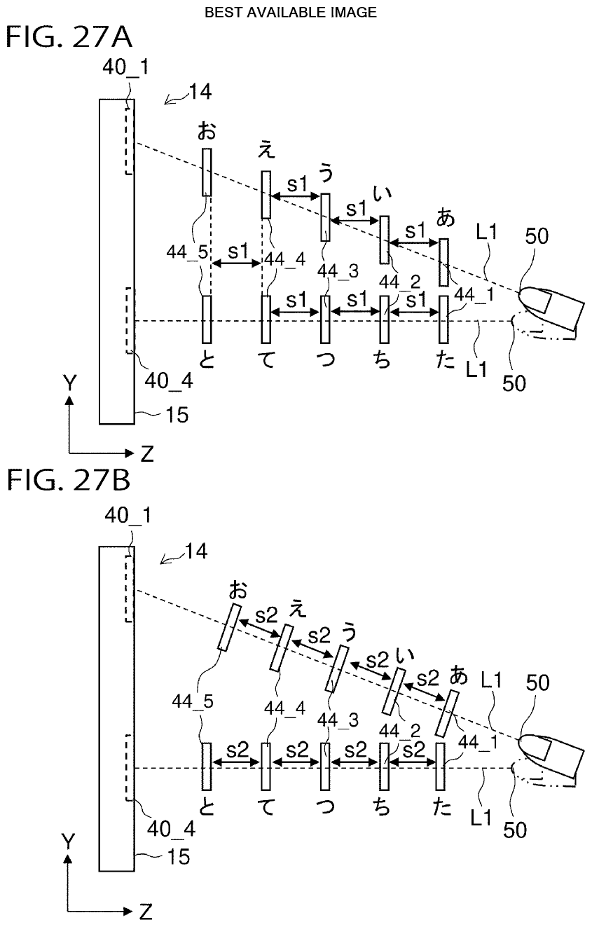

FIGS. 27A and 27B show various setting examples of the determination region 44 in the information processing system 1. FIG. 27A shows a first setting example of the determination region 44. Regardless of the angle between the straight line L1 and the display surface 15, a plurality of determination regions 44 are parallel to the display surface 15. Regardless of the angle between the straight line L1 and the display surface 15, the intervals s1 along the normal line of the display surface 15 of two adjacent determination regions 44 are equal. For example, the interval s1 along the normal line of the display surface 15 between the first determination region 44_1 and the second determination region 44_2 is equal to the interval s1 along the normal line of the display surface 15 between the second determination region 44_2 and the third determination region 44_3.

FIG. 27B shows a second setting example of the determination region 44. Regardless of the angle between the straight line L1 and the display surface 15, a plurality of determination regions 44 are perpendicular to the straight line L1. Regardless of the angle between the straight line L1 and the display surface 15, the intervals s2 along the straight line L1 of two adjacent determination regions 44 are equal. For example, the interval s2 along the straight line L1 between the first determination region 44_1 and the second determination region 44_2 is equal to the interval s2 along the straight line L1 between the second determination region 44_2 and the third determination region 44_3. In this example, the movement distance of the fingertip 50 between two adjacent determination regions 44 can be equal, regardless of the direction in which the fingertip 50 is moved.

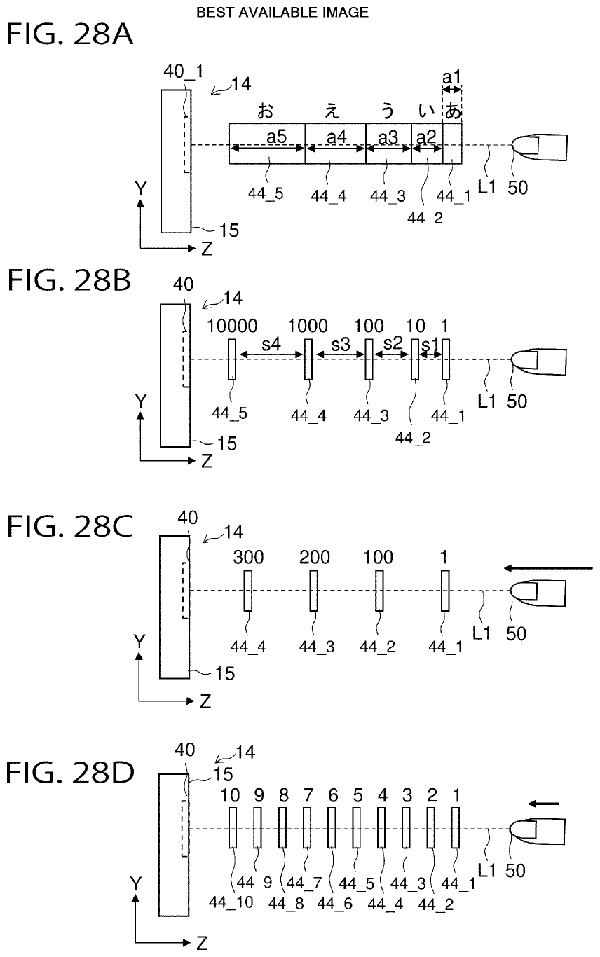

FIGS. 28A to 28D show another setting example of the determination region 44 in the information processing system 1. FIG. 28A shows a third setting example of the determination region 44. The setting unit 32 arranges a plurality of determination regions 44 in such a manner of being adjacent to each other along the straight line L1.

The setting unit 32 sets the length of the determination region 44 along the straight line L1 to be longer as the determination region 44 is farther away from the location of the fingertip 50 at the reference time. For example, the length a2 along the straight line L1 of the second determination region 44_2 is longer than the length a1 along the straight line L1 of the first determination region 44_1. In addition, the volume of the second determination region 44_2 is larger than the volume of the first determination region 44_1.

As the arm is extended and the fingertip 50 is farther away from the user's body, the blurring of the fingertip 50 location tends to increase, and in this situation, it is still easy to select the determination region 44. Therefore, it is easy to select the determination region 44 that is closer to the display surface 15.

FIG. 28B shows a fourth setting example of the determination region 44. In the examples shown from FIG. 28B to FIG. 28D, the characters are numbers. The setting unit 32 sets the interval along the straight line L1 between two adjacent determination regions 44 to be wider as the distance from the location of the fingertip 50 at the reference time is increased.

The interval s2 along the straight line L1 between the second determination region 44_2 and the third determination region 44_3 is wider than the interval s1 along the straight line L1 between the first determination region 44_1 and the second determination region 44_2. The interval s3 along the straight line L1 between the third determination region 44_3 and the fourth determination region 44_4 is wider than the interval s2. The interval s4 along the straight line L1 between the fourth determination region 44_4 and the fifth determination region 44_5 is wider than the interval s3.

The first character information corresponding to the first determination region 44_1 is a number obtained by repeatedly multiplying a predetermined number by a first exponent. For example, the predetermined number is “10” and the first index is “0”. The second character information corresponding to the second determination region 44_2 is a number obtained by repeatedly multiplying a predetermined number by a second exponent greater than the first exponent. For example, the second index is “1”.

The third character information corresponding to the third determination region 44_3 is a number obtained by repeatedly multiplying a predetermined number by a third exponent greater than the second exponent. For example, the third index is “2”. The fourth character information corresponding to the fourth determination region 44_4 is a number obtained by repeatedly multiplying a predetermined number by a fourth exponent greater than the third exponent. For example, the fourth index is “3”. The fifth character information corresponding to the fifth determination region 44_5 is a number obtained by repeatedly multiplying a predetermined number by a fifth exponent greater than the fourth exponent. For example, the fifth index is “4”.

In this setting example, a number that changes by repeated multiplications can be selected. Selecting a greater number requires moving the fingertip 50 a longer distance, making the selection more intuitive.

FIG. 28C shows a setting example of the determination region when the moving speed of the fingertip 50 is relatively fast. FIG. 28D shows a setting example of the determination region when the moving speed of the fingertip 50 is relatively slow. The calculation unit 28 periodically calculates the moving speed of the fingertip 50 and outputs the calculated moving speed to the determination unit 30. The determination unit 30 compares the moving speed of the fingertip 50 supplied from the calculation unit 28 with the speed threshold and outputs the comparison results to the setting unit 32. One or more speed thresholds are preset.

Based on the comparison results supplied from the determination unit 30, the setting unit 32 sets the interval along the straight line L1 of a plurality of determination regions 44 to be wider and the number of determination regions 44 to be reduced as the moving speed of the fingertip 50 at a predetermined time after the reference time increases. The predetermined time can be determined according to experiments or simulations as appropriate. As a result, it is easy to select the determination region 44 when the moving speed of the fingertip 50 is fast.

The setting unit 32 associates a greater number as the determination region 44 is farther away from the location of the fingertip 50 at the reference time. The setting unit 32 sets the difference between the number associated with one of two adjacent determination regions 44 and the number associated with the other determination region 44 to be larger as the moving speed of the fingertip 50 at the predetermined time after the reference time increases. In this way, a greater number can be selected when the moving speed of the fingertip 50 is faster than when the moving speed is slower.

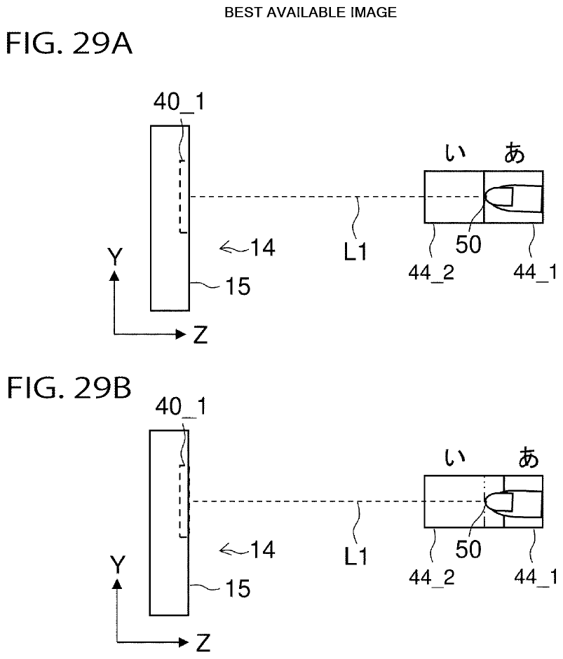

FIGS. 29A and 29B show further setting examples of the determination region 44 in the information processing system 1. In FIGS. 29A and 29B, the illustration of the determination regions 44 other than the first determination region 44_1 and the second determination region 44_2 are omitted. FIG. 29A shows the standard size of the determination region 44. FIG. 29B shows the determination region 44 having a changed size.

The setting unit 32 arranges a plurality of determination regions 44 in such a manner of being adjacent to each other along the straight line L1. In a case where the fingertip 50 is located in the second determination region 44_2, the setting unit 32 widens the second determination region 44_2 toward a side of the first determination region 44_1 and narrows the first determination region 44_1.

In a case where the fingertip 50 then moves from the second determination region 44_2 to the first determination region 44_1, the setting unit 32 returns the sizes of the first determination region 44_1 and the second determination region 44_2 to their original sizes. In other words, the setting unit 32 returns those sizes to the standard size of the determination region 44 in FIG. 29A.

In this example, it is possible to suppress frequent switching and instability of the characters displayed in the display region 40 in a case where the fingertip 50 is located at the boundary of the first determination region 44_1 and the second determination region 44_2 having the standard size.

### Seventh Embodiment

In the seventh embodiment, it is different from the first embodiment in that the character can be selected without pointing the fingertip 50 at the display region 40. The following description focuses on the differences from the first embodiment.

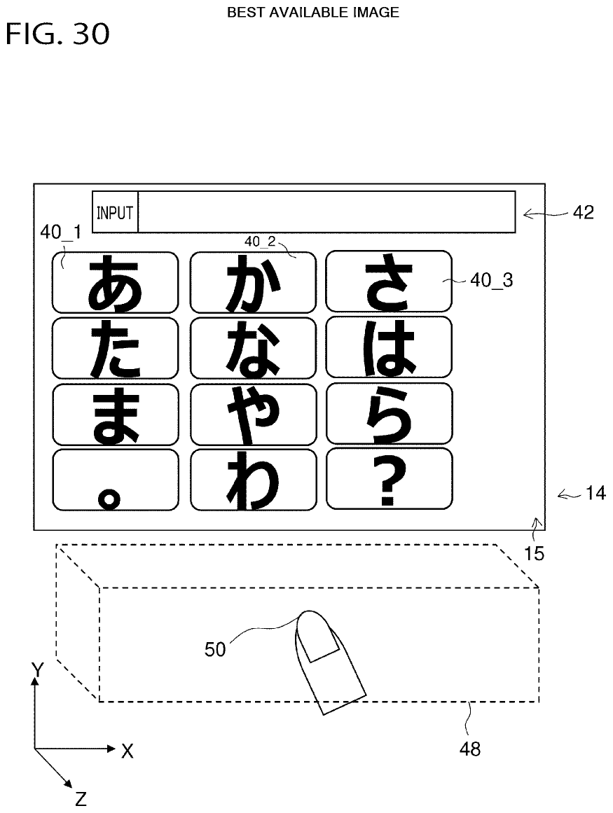

FIG. 30 is a diagram of the display 14 for describing the character input operation in the information processing system 1 of the seventh embodiment. A predetermined input space 48 is set in a location that does not overlap the display surface 15 of the display 14. In a case where the user starts to input characters, the user places the fingertip 50 into the input space 48.

The determination unit 30 determines whether or not the fingertip 50 enters the input space 48. The fingertip 50 entering the input space 48 corresponds to the input start condition being satisfied. The determination unit 30 outputs to the setting unit 32 the determination result and the spatial coordinates of the fingertip 50 at the reference time that is the time when the input start condition was satisfied.

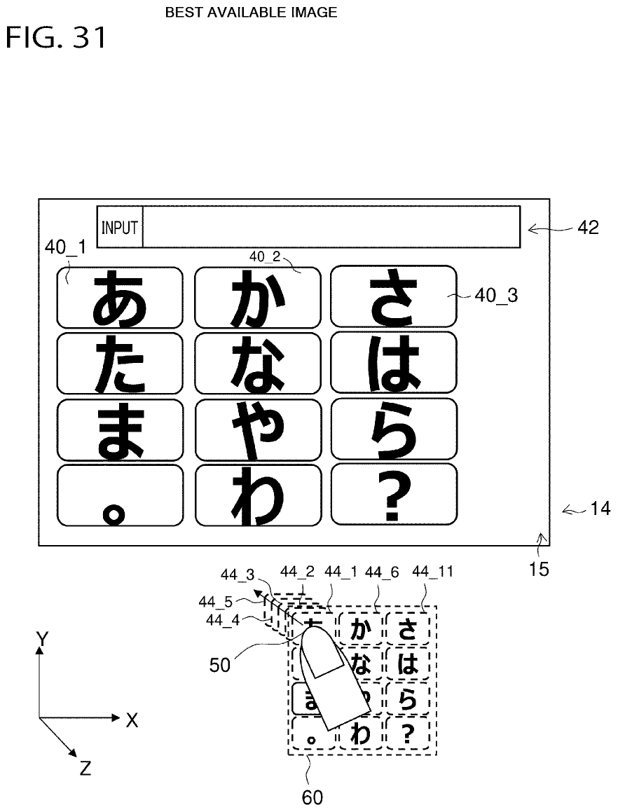

FIG. 31 is a diagram for describing a character input operation following FIG. 30. The setting unit 32 sets a plurality of determination regions 44 on the topmost layer in a plane 60 parallel to the display surface 15, with reference to the spatial coordinates of the fingertip 50 at the reference time. The number of determination regions 44 in the plane 60 is equal to the number of display regions 40, which is “12” in this example. The setting unit 32 sets the first determination region 44_1, which overlaps the spatial coordinates of the fingertip 50 at the reference time, and sets a plurality of other determination regions 44 in the plane 60 in a matrix. The setting unit 32 sets a plurality of determination regions 44 on the lower layer in a direction parallel to the Z axis. For example, the first determination region 44_1, the second determination region 44_2, the third determination region 44_3, the fourth determination region 44_4, and the fifth determination region 44_5 are set apart in a direction parallel to the Z axis. FIG. 31 shows a part of the determination region 44 on the lower layer.

A plurality of pieces of character information included in a plurality of character information groups are preliminarily associated with a plurality of determination regions 44 on a one-to-one basis.

The user selects the character information associated with any of the plurality of determination regions 44 by moving the fingertip 50 in the plane 60 and in the direction parallel to the Z axis.

After the plurality of determination regions 44 are set, the determination unit 30 determines whether or not the fingertip 50 is located in any of the plurality of determination regions 44.

In a case where the determination unit 30 determines that the fingertip 50 is located in the j-th determination region 44_j, the display output unit 36 displays the character information associated with the j-th determination region 44_j in the display region 40 associated with the character information group including the character information. For example, in a case where the fingertip 50 is located in the third determination region 44_3, the character “ [symbol] ” reading “u” is displayed in the first display region 40_1 instead of the character “ [symbol] ” reading “a”.

In a case where the determination unit 30 determines that the fingertip 50 is located in the j-th determination region 44_j and the determination operation has been performed, the function execution unit 34 determines character information associated with the j-th determination region 44_j and accepts an input of the character information.

In a case where the determination unit 30 determines that the fingertip 50 is located in the j-th determination region 44_j and the determination operation has been performed, the display output unit 36 displays the character information associated with the j-th determination region 44_j in the input display region 42.

Thus, the first determination region 44_1 can be set at the desired location of the user in the input space 48. Therefore, it is easy to select the character information by the aerial movement.

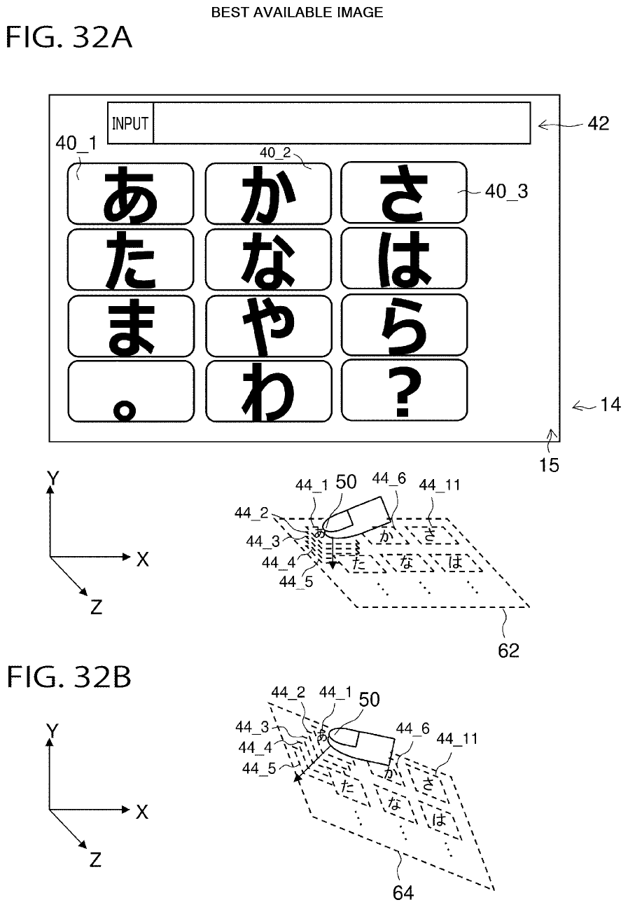

FIGS. 32A and 32B show another setting example of a plurality of determination regions 44 of the seventh embodiment. FIG. 32A is a diagram for describing an example in which a plurality of determination regions 44 are set parallel to the XZ plane.

The setting unit 32 sets a plurality of determination regions 44 on the topmost layer in a plane 62 that intersects the display surface 15, the plane 62 being parallel to the XZ plane. The setting unit 32 sets a plurality of determination regions 44 on the lower layer in a direction parallel to the Y axis. For example, the first determination region 44_1, the second determination region 44_2, the third determination region 44_3, the fourth determination region 44_4, and the fifth determination region 44_5 are set apart in a direction parallel to the Y axis. FIGS. 32A and 32B show parts of the determination region 44 on the topmost layer and the lower layer.

FIG. 32B is a diagram for describing an example in which a plurality of determination regions 44 are set non-parallel to the XY plane, the XZ plane, and the ZY plane. In FIG. 32B, the illustration of the display surface 15 is omitted.

The setting unit 32 sets a plurality of determination regions 44 on the topmost layer in the plane 64 intersecting the display surface 15, the XZ plane, and the ZY plane. The setting unit 32 sets a plurality of determination regions 44 on the lower layer in the normal line direction of the plane 64. For example, the first determination region 44_1, the second determination region 44_2, the third determination region 44_3, the fourth determination region 44_4, and the fifth determination region 44_5 are set apart in the normal line direction of the plane 64.

In the example in FIGS. 32A and 32B, character information can be selected by moving the fingertip 50 in the plane 62 that intersects the display surface 15 and in the normal line direction of the plane 62.

Note that in a case where the fingertip 50 enters the input space 48, the setting unit 32 may set a plurality of determination regions 44 at predetermined locations without reference to the location of the fingertip 50.

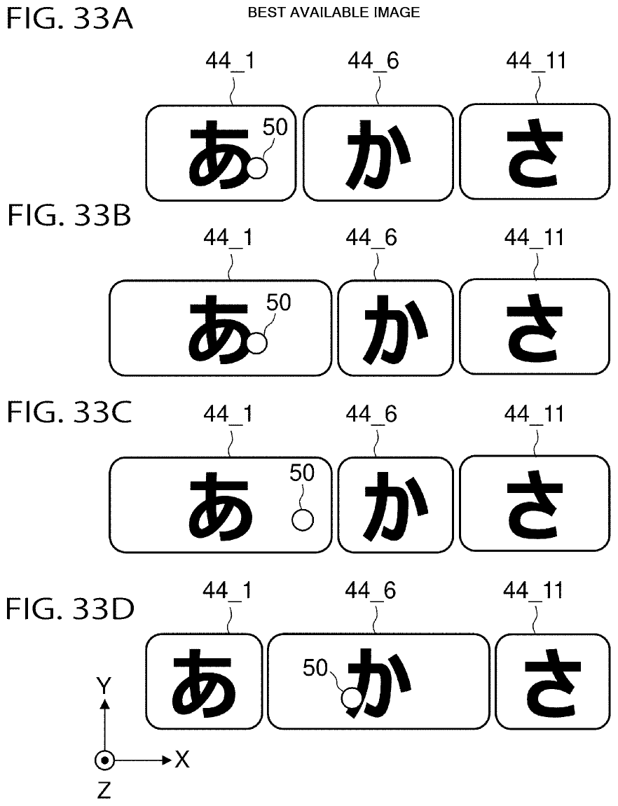

FIGS. 33A to 33D are diagrams for describing the size change process of the determination region 44 in the information processing system 1 of the seventh embodiment. FIGS. 33A to 33D show the first determination region 44_1, the sixth determination region 44_6, and the eleventh determination region 44_11, which are adjacent to each other in the X axis direction, of a plurality of determination regions 44 in the plane 60 of FIG. 31.

FIG. 33A shows the standard size of the determination region 44. FIG. 33B shows the determination region 44 having a changed size, following FIG. 33A. FIG. 33C shows the determination region 44 having a changed size, following FIG. 33B. FIG. 33D shows the determination region 44 having a changed size, following FIG. 33C.

As shown in FIG. 33A and FIG. 33B, in a case where the fingertip 50 is located in the first determination region 44_1, the setting unit 32 widens the first determination region 44_1 toward a side of the sixth determination region 44_6 and an opposite side of the sixth determination region 44_6, and narrows the sixth determination region 44_6.

In a case where the fingertip 50 then moves from the widened first determination region 44_1 to the narrowed sixth determination region 44_6, the setting unit 32 widens the sixth determination region 44_6 toward a side of the first determination region 44_1 and a side of the eleventh determination region 44_11, and narrows the first determination region 44_1.

The setting unit 32 executes the above process in a case where the fingertip 50 is located in any of the plurality of determination regions 44.

In this example, in a case where the fingertip 50 is located at the boundary of the first determination region 44_1 and the sixth determination region 44_6 having the standard size, it is possible to suppress false input.

Note that in a case where the fingertip 50 is located in the first determination region 44_1, the setting unit 32 may widen the first determination region 44_1 only on a side of the sixth determination region 44_6, widen the first determination region 44_1 in the up and down direction, or widen the first determination region 44_1 in the up and down direction and in the left and right direction.

The present disclosure is described above based on the embodiments. It is understood by those skilled in the art that these embodiments are examples and that various modifications are possible in the combination of their respective components or respective processing processes, and that such modifications are also within the scope of the present disclosure.

For example, the fifth embodiment may be combined with the third embodiment. The new embodiment resulting from the combination has the combined effects of each of the combined embodiments.

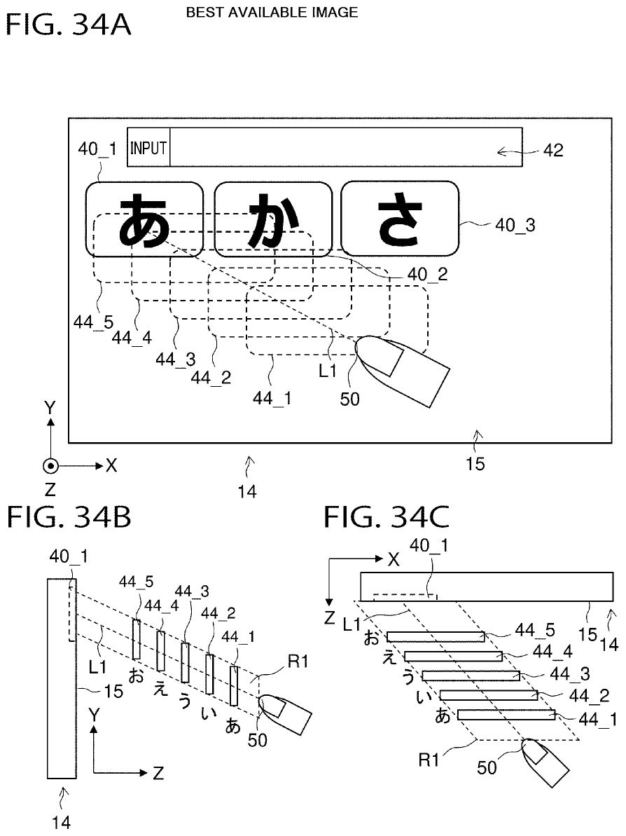

In each of the first embodiment, the second embodiment, the third embodiment, the fourth embodiment, the fifth embodiment, and the sixth embodiment, the cross-sectional area of each of the determination region 44 and the selection region R1 in the cross-section parallel to the display surface 15 may be larger than the area of the display region 40. FIGS. 34A to 34C are diagrams for describing the character input operation in the information processing system 1 of the modification of the first embodiment. FIG. 34A is a plan view of the display 14, FIG. 34B is a side view of the display 14, and FIG. 34C is a top view of the display 14.

As shown in FIGS. 34A to 34C, in a cross-section parallel to the display surface 15, each of the determination region 44 and the selection region R1 is longer than the display region 40 in the direction of the X axis. Therefore, compared to the example in FIGS. 3A to 3C, the fingertip 50 is less likely to deviate from the determination region 44 and the selection region R1 in the left and right direction. Thus, even when the fingertip 50 moves unintentionally toward a side of the second display region 40_2, for example, due to confusion about the character to be input, it is more difficult to designate an unintended second display region 40_2 compared to the example in FIGS. 3A to 3C. Also, even when the location of the fingertip 50 is blurred in the left and right direction during the determination operation, input errors can be suppressed compared to the example in FIGS. 3A to 3C.

Note that in the cross-section parallel to the display surface 15, each of the determination region 44 and the selection region R1 may be longer than the display region 40 in the direction of the Y axis. In this case, compared to the example in FIGS. 3A to 3C, the fingertip 50 is less likely to deviate from the determination region 44 and the selection region R1 in the up and down direction. Also, in a cross-section parallel to the display surface 15, each of the determination region 44 and the selection region R1 may be longer than the display region 40 in the respective directions of the X axis and the Y axis. In this case, compared to the example in FIGS. 3A to 3C, the fingertip 50 is less likely to deviate from the determination region 44 and the selection region R1 in the up and down direction and in the left and right direction.

One aspect of the present disclosure is as follows.

### Item 1

A control apparatus including:
a coordinate reception unit structured to receive spatial coordinates of a detection object located in front of a display surface of a display;
a setting unit structured to set a first determination region associated with first character information included in a first character information group based on coordinates of a first display region in which information on the first character information group is displayed on the display surface and spatial coordinates of the detection object at a reference time that is a time when the first display region is designated by the detection object;
a determination unit structured to determine whether or not the detection object is located in the first determination region after the first determination region is set; and
a display output unit structured to display the first character information in the first display region in a case where the determination unit determines that the detection object is located in the first determination region.

According to the present aspect, a determination region related to a display region designated by a user can be set at a desired location. Thus, regardless of a size of a display surface of a display, it is easy to select character information by an aerial movement.

### Item 2

The control apparatus according to item 1, in which
the setting unit sets the first determination region to intersect a straight line that connects spatial coordinates of the detection object at the reference time and the first display region.

In this case, first character information can be selected by moving a detection object close to a first display region from any direction with respect to a display surface.

### Item 3

The control apparatus according to item 1, in which
the setting unit sets the first determination region to intersect a straight line that connects spatial coordinates of the detection object at the reference time and the display surface, the straight line being a normal line to the display surface.

In this case, first character information can be selected by moving a detection object close to a display surface in a normal line direction of a display surface.

### Item 4

The control apparatus according to item 2 or 3, in which
the setting unit sets a second determination region associated with a second character information included in the first character information group to intersect the straight line,
the determination unit determines whether or not the detection object is located in the second determination region after the second determination region is set, and
the display output unit displays the second character information in the first display region in a case where the determination unit determines that the detection object is located in the second determination region.

In this case, first character information or second character information can be selected by moving a detection object close to a display surface.

### Item 5

The control apparatus according to any of items 1 to 3, in which
the display output unit displays information on a second character information group in a second display region of the display surface,
the determination unit determines whether or not the detection object has designated any of the first display region or the second display region based on spatial coordinates of the detection object, coordinates of the first display region, and coordinates of the second display region, and
the setting unit
sets the first determination region by associating the first character information with the first determination region in a case where the determination unit determines that the detection object has designated the first display region; and
sets the first determination region, based on spatial coordinates of the detection object at the reference time that is a time when the second display region is designated by the detection object, by associating second character information included in the second character information group with the first determination region in a case where the determination unit determines that the detection object has designated the second display region.

In this case, a desired character information group can be designated.

### Item 6

The control apparatus according to item 2, in which
the display output unit displays the first character information in the first display region and displays second character information associated with the first character information in the second display region adjacent to the first display region in a case where the determination unit determines that the detection object is located in the first determination region.

In this case, related second character information can be displayed next to selected first character information.

### Item 7

The control apparatus according to item 6, in which
the setting unit sets a second determination region associated with third character information included in the first character information group to intersect the straight line,
the determination unit determines whether or not the detection object is located in the second determination region after the second determination region is set, and
the display output unit displays the third character information in the first display region and displays fourth character information associated with the third character information in the second display region in a case where the determination unit determines that the detection object is located in the second determination region.

In this case, first character information or third character information can be selected, and related character information can be displayed next to selected character information.

### Item 8

The control apparatus according to item 6 or 7, in which
the display surface has an input display region in which an input character is displayed,
the determination unit determines whether or not a first determination operation or a second determination operation is performed by the detection object, and whether or not the detection object has designated the second display region, and
the display output unit
displays the first character information in the input display region in a case where the determination unit determines that the detection object is located in the first determination region and that the first determination operation has been performed, and
displays the second character information in the input display region in a case where the determination unit determines that the detection object has designated the second display region and that the second determination operation has been performed.

In this case, first character information or second character information can be input.

### Item 9

The control apparatus according to item 4, in which
the first character information and the second character information each include information on one or a plurality of words starting with a predetermined character.

In this case, a word can be selected.

### Item 10

The control apparatus according to item 4, in which
the setting unit sets a third determination region associated with third character information included in the first character information group to intersect the straight line,
the first determination region, the second determination region, and the third determination region are arranged in order from a side of the detection object to a side of the display surface, and
an interval along the straight line between the first determination region and the second determination region is equal to an interval along the straight line between the second determination region and the third determination region.

In this case, a movement distance of a detection object between two adjacent determination regions can be equal regardless of a location of a detection object at a reference time.

### Item 11

The control apparatus according to item 4, in which
the setting unit sets an interval along the straight line between the first determination region and the second determination region to be wider as a moving speed of the detection object at a predetermined time after the reference time increases.

In this case, it is easy to select a determination region in a case where a moving speed of a detection object is fast.

### Item 12

The control apparatus according to item 11, in which
the first character information and the second character information are numerical information, respectively, and
the setting unit sets a difference between numerals in the first character information and numerals in the second character information to be larger as a moving speed of the detection object at the predetermined time after the reference time increases.

In this case, selectable numerals can be changed according to a moving speed of a detection object.

### Item 13

The control apparatus according to item 4, in which
the second determination region is located on a side of the display surface closer than the first determination region, and
a volume of the second determination region is larger than a volume of the first determination region.

In this case, it is easy to select a determination region close to a display surface.

### Item 14

The control apparatus according to item 4, in which
the second determination region is located on a side of the display surface closer than the first determination region, and
the cross-sectional area of the second determination region in a cross-section parallel to the display surface is larger than the cross-sectional area of the first determination region in a cross-section parallel to the display surface.

In this case, it is easy to select a determination region close to a display surface.

### Item 15

The control apparatus according to item 4, in which
the second determination region is located on a side of the display surface closer than the first determination region, and
a length of the second determination region along the straight line is longer than a length of the first determination region along the straight line.

In this case, it is easy to select a determination region close to a display surface.

### Item 16

The control apparatus according to item 4, in which
the setting unit sets a third determination region associated with third character information included in the first character information group to intersect the straight line,
the first determination region, the second determination region, and the third determination region are arranged in order from a side of the detection object to a side of the display surface,
an interval along the straight line between the second determination region and the third determination region is wider than an interval along the straight line between the first determination region and the second determination region,
the first character information is a number obtained by repeatedly multiplying a predetermined number by a first exponent,
the second character information is a number obtained by repeatedly multiplying the predetermined number by a second exponent that is greater than the first exponent, and
the third character information is a number obtained by repeatedly multiplying the predetermined number by a third exponent that is greater than the second exponent.

In this case, a number that changes by repeated multiplications can be selected.

### Item 17

The control apparatus according to item 4, in which
the first determination region and the second determination region are adjacent to each other along the straight line, and
the setting unit widens the second determination region toward a side of the first determination region and narrows the first determination region in a case where the detection object is located in the second determination region.

In this case, an unstable display of character information can be suppressed in a case where a detection object is located at a boundary of a first determination region and a second determination region.

### Item 18

The control apparatus according to any one of items 1 to 5 and items 9 to 17, in which
the display surface has an input display region in which an input character is displayed,
the determination unit determines whether or not a determination operation has been performed by the detection object, and
the display output unit displays the first character information in the input display region in a case where the determination unit determines that the detection object is located in the first determination region and that a determination operation has been performed.

In this case, character information can be input.

### Item 19

A control apparatus including:
a coordinate reception unit structured to receive spatial coordinates of a first detection object and a second detection object located in front of a display surface of a display;
a setting unit structured to set a first determination region associated with first character information included in a first character information group based on spatial coordinates of the first detection object at a reference time that is a time when a predetermined input start condition is satisfied, and set a second determination region associated with second character information included in a second character information group based on spatial coordinates of the second detection object at the reference time;
a determination unit structured to determine whether or not the first detection object is located in the first determination region and whether or not the second detection object is located in the second determination region after the first determination region and the second determination region are set; and
a display output unit structured to display the first character information in a first display region of the display surface in a case where the determination unit determines that the first detection object is located in the first determination region, and display the second character information in a second display region of the display surface in a case where the determination unit determines that the second detection object is located in the second determination region.

According to the present aspect, character information can be selected by a plurality of detection objects.

### Item 20

The control apparatus according to item 19, in which
the setting unit
sets the first determination region to intersect a first straight line that connects spatial coordinates of the first detection object at the reference time and the first display region, and
sets the second determination region to intersect a second straight line that connects spatial coordinates of the second detection object at the reference time and the second display region.

In this case, first character information can be selected by moving a first detection object close to a first display region from any direction with respect to a display surface. Second character information can be selected by moving a second detection object close to a second display region from any direction with respect to a display surface.

### Item 21

The control apparatus according to item 19 in which
the setting unit
sets the first determination region to intersect a first straight line that connects spatial coordinates of the first detection object at the reference time and the display surface, the first straight line being a normal line of the display surface, and
sets the second determination region to intersect a second straight line that connects spatial coordinates of the second detection object at the reference time and the display surface, the second straight line being a normal line of the display surface.

In this case, first character information can be selected by moving a first detection object close to a display surface in a normal line direction of a display surface. Second character information can be selected by moving a second detection object close to a display surface in a normal line direction of a display surface.

### Item 22

The control apparatus according to item 20 or 21, in which
the setting unit
sets a third determination region associated with third character information included in the first character information group to intersect the first straight line, and
sets a fourth determination region associated with fourth character information included in the second character information group to intersect the second straight line,
the determination unit
determines whether or not the first detection object is located in the third determination region after the third determination region is set, and
determines whether or not the second detection object is located in the fourth determination region after the fourth determination region is set, and
the display output unit
displays the third character information in the first display region in a case where the determination unit determines that the first detection object is located in the third determination region, and
displays the fourth character information in the second display region in a case where the determination unit determines that the second detection object is located in the fourth determination region.

In this case, first character information or third character information can be selected by moving a first detection object close to a display surface. Second character information or fourth character information can be selected by moving a second detection object close to a display surface.

### Item 23

A control apparatus including:
a coordinate reception unit structured to receive spatial coordinates of a detection object located in front of a display surface of a display;
a setting unit structured to set a first determination region associated with first character information with reference to spatial coordinates of the detection object when the detection object enters a predetermined input space;
a determination unit structured to determine whether or not the detection object is located in the first determination region after the first determination region is set; and
a display output unit structured to display the first character information on the display surface in a case where the determination unit determines that the detection object is located in the first determination region.

According to the present aspect, a first determination region can be set at a desired location of a user in an input space. Therefore, it is easy to select the character information by the aerial movement.

### Item 24

The control apparatus according to item 23, in which
the setting unit sets the first determination region and the second determination region associated with second character information in a plane parallel to the display surface or in a plane intersecting the display surface,
the determination unit determines whether or not the detection object is located in the second determination region after the second determination region is set, and
the display output unit displays the second character information on the display surface in a case where the determination unit determines that the detection object is located in the second determination region.

In this case, character information can be selected in a plane parallel to a display surface or in a plane intersecting a display surface.

### Item 25

The control apparatus according to item 24, in which
the first determination region and the second determination region are adjacent to each other, and
the setting unit widens the first determination region toward a side of the second determination region and narrows the second determination region in a case where the detection object is located in the first determination region.

In this case, an unstable display of character information can be suppressed in a case where a detection object is located at a boundary of a first determination region and a second determination region.

### Item 26

A control method including:
receiving spatial coordinates of a detection object located in front of a display surface of a display;
setting a first determination region associated with first character information included in a first character information group based on coordinates of a first display region in which information on the first character information group is displayed on the display surface and spatial coordinates of the detection object at a reference time that is a time when the first display region is designated by the detection object;
determining whether or not the detection object is located in the first determination region after the first determination region is set; and
displaying the first character information in the first display region in a case where it is determined that the detection object is located in the first determination region.

According to the present aspect, it is easy to select character information by aerial movement, regardless of a size of a display surface of a display.

### Item 27

A control method including:
receiving spatial coordinates of a first detection object and a second detection object located in front of a display surface of a display;
setting a first determination region associated with first character information included in a first character information group based on spatial coordinates of the first detection object at a reference time that is a time when a predetermined input start condition is satisfied, and setting a second determination region associated with second character information included in a second character information group based on spatial coordinates of the second detection object at the reference time;
determining whether or not the first detection object is located in the first determination region and whether or not the second detection object is located in the second determination region after the first determination region and the second determination region are set; and
displaying the first character information in a first display region of the display surface in a case where it is determined that the first detection object is located in the first determination region, and displaying the second character information in a second display region of the display surface in a case where it is determined that the second detection object is located in the second determination region.

According to the present aspect, character information can be selected by a plurality of detection objects.

### Item 28

A control method including:
receiving spatial coordinates of a detection object located in front of a display surface of a display;
setting a first determination region associated with first character information with reference to spatial coordinates of the detection object when the detection object enters a predetermined input space;
determining whether or not the detection object is located in the first determination region after the first determination region is set; and
displaying the first character information on the display surface in a case where it is determined that the detection object is located in the first determination region.

According to the present aspect, it is easy to select character information by an aerial movement.

While various embodiments have been described herein above, it is to be appreciated that various changes in form and detail may be made without departing from the spirit and scope of the invention (s) presently or hereafter claimed.

### CROSS-REFERENCE TO RELATED APPLICATIONS

This application is based upon and claims the benefit of priority from the prior Japanese Patent Application No. 2022-193227, filed on Dec. 2, 2022, the entire contents of which are incorporated herein by reference.

What is claimed is:

1. A control apparatus comprising:
a memory in which a program is stored; and
a processor coupled to the memory and configured to perform processing by executing the program, the processing including:
receiving spatial coordinates of a detection object located in front of a display surface of a display;
setting a first determination region associated with first character information included in a first character information group based on coordinates of a first display region in which information on the first character information group is displayed on the display surface and spatial coordinates of the detection object at a reference time that is a time when the first display region is designated by the detection object;
determining whether or not the detection object is located in the first determination region after the first determination region is set; and
controlling the display to display the first character information in the first display region in a case where it is determined that the detection object is located in the first determination region.

2. The control apparatus according to claim 1, wherein
setting the first determination region includes setting the first determination region to intersect a straight line that connects spatial coordinates of the detection object at the reference time and the first display region.

3. The control apparatus according to claim 1, wherein
setting the first determination region includes setting the first determination region to intersect a straight line that connects spatial coordinates of the detection object at the reference time and the display surface, the straight line being a normal line of the display surface.

4. The control apparatus according to claim 2, wherein
the processing includes:
setting a second determination region associated with second character information included in the first character information group to intersect the straight line;
determining whether or not the detection object is located in the second determination region after the second determination region is set; and
controlling the display to display the second character information in the first display region in a case where it is determined that the detection object is located in the second determination region.

5. The control apparatus according to claim 1, wherein
the processing includes:
controlling the display to display information on a second character information group in a second display region of the display surface; and
determining whether or not the detection object has designated any of the first display region or the second display region based on spatial coordinates of the detection object, coordinates of the first display region, and coordinates of the second display region, and
setting the first determination region includes:
setting the first determination region by associating the first character information with the first determination region in a case where the detection object is determined to have designated the first display region; and
setting the first determination region, based on spatial coordinates of the detection object at the reference time that is a time when the second display region is designated by the detection object, by associating second character information included in the second character information group with the first determination region in a case where the detection object is determined to have designated the second display region.

6. The control apparatus according to claim 2, wherein
controlling the display to display the first character information in the first display region includes controlling the display to display the first character information in the first display region and display second character information associated with the first character information in the second display region adjacent to the first display region, in a case where it is determined that the detection object is located in the first determination region.

7. The control apparatus according to claim 6, wherein
the processing includes:
setting a second determination region associated with third character information included in the first character information group to intersect the straight line;
determining whether or not the detection object is located in the second determination region after the second determination region is set; and
controlling the display to display the third character information in the first display region and display the fourth character information associated with the third character information in the second display region in a case where it is determined that the detection object is located in the second determination region.

8. The control apparatus according to claim 6, wherein
the display surface has an input display region in which an input character is displayed,
the processing includes determining whether or not a first determination operation or a second determination operation is performed by the detection object and whether or not the detection object has designated the second display region, and
controlling the display to display the first character information in the first display region includes:
controlling the display to display the first character information in the input display region in a case where it is determined that the detection object has been located in the first determination region and a first determination operation has been performed; and
controlling the display to display the second character information in the input display region in a case where it is determined that the detection object has designated the second display region and a second determination operation has been performed.

9. The control apparatus according to claim 4, wherein
the processing includes setting an interval along the straight line between the first determination region and the second determination region to be wider as a moving speed of the detection object at a predetermined time after the reference time increases.

10. The control apparatus according to claim 9, wherein
the first character information and the second character information are numerical information, respectively, and
the processing includes setting a difference between numerals in the first character information and numerals in the second character information to be larger as a moving speed of the detection object at the predetermined time after the reference time increases.

11. The control apparatus according to claim 4, wherein
the second determination region is located on a side of the display surface closer than the first determination region, and
a volume of the second determination region is larger than a volume of the first determination region.

12. The control apparatus according to claim 4, wherein
the first determination region and the second determination region are adjacent to each other along the straight line, and
the processing includes widening the second determination region toward a side of the first determination region and narrowing the first determination region in a case where the detection object is located in the second determination region.

13. The control apparatus according to claim 1, wherein
the display surface has an input display region in which an input character is displayed, and
the processing includes:
determining whether or not a determination operation has been performed by the detection object; and
controlling the display to display the first character information in the input display region in a case where it is determined that the detection object has been located in the first determination region and a determination operation has been performed.

14. A control apparatus comprising:
a memory in which a program is stored; and
a processor coupled to the memory and configured to perform processing by executing the program, the processing including:
receiving spatial coordinates of a first detection object and a second detection object located in front of a display surface of a display;
setting a first determination region associated with first character information included in a first character information group based on spatial coordinates of the first detection object at a reference time that is a time when a predetermined input start condition is satisfied, and setting a second determination region associated with second character information included in a second character information group based on spatial coordinates of the second detection object at the reference time;
determining whether or not the first detection object is located in the first determination region and whether or not the second detection object is located in the second determination region after the first determination region and the second determination region are set; and
controlling the display to display the first character information in a first display region of the display surface in a case where it is determined that the first detection object is located in the first determination region, and controlling the display to display the second character information in a second display region of the display surface in a case where it is determined that the second detection object is located in the second determination region.

15. The control apparatus according to claim 14, wherein
setting the first determination region includes setting the first determination region to intersect a first straight line that connects spatial coordinates of the first detection object at the reference time and the first display region, and
setting the second determination region includes setting the second determination region to intersect a second straight line that connects spatial coordinates of the second detection object at the reference time and the second display region.

16. The control apparatus according to claim 14, wherein
setting the first determination region includes setting the first determination region to intersects a first straight line that connects spatial coordinates of the first detection object at the reference time and the display surface, the first straight line being a normal line of the display surface, and
setting the second determination region includes setting the second determination region to intersect a second straight line that connects spatial coordinates of the second detection object at the reference time and the display surface, the second straight line being a normal line of the display surface.

17. The control apparatus according to claim 15, wherein
the processing includes:
setting a third determination region associated with third character information included in the first character information group to intersect the first straight line;
setting a fourth determination region associated with fourth character information included in the second character information group to intersect the second straight line;
determining whether or not the first detection object is located in the third determination region after the third determination region is set;
determining whether or not the second detection object is located in the fourth determination region after the fourth determination region is set;
controlling the display to display the third character information in the first display region in a case where it is determined that the first detection object is located in the third determination region; and
controlling the display to display the fourth character information in the second display region in a case where it is determined that the second detection object is located in the fourth determination region.

18. A control apparatus comprising:
a memory in which a program is stored; and
a processor coupled to the memory and configured to perform processing by executing the program, the processing including:
receiving spatial coordinates of a detection object located in front of a display surface of a display;
setting a first determination region associated with first character information with reference to spatial coordinates of the detection object when the detection object enters the predetermined input space;
determining whether or not the detection object is located in the first determination region after the first determination region is set; and
controlling the display to display the first character information on the display surface in a case where it is determined that the detection object is located in the first determination region.

19. The control apparatus according to claim 18, wherein
setting the first determination region includes setting the first determination region and a second determination region associated with second character information in a plane parallel to the display surface or in a plane intersecting the display surface, and
the processing includes:
determining whether or not the detection object is located in the second determination region after the second determination region is set; and
controlling the display to display the second character information on the display surface in a case where it is determined that the detection object is located in the second determination region.

20. The control apparatus according to claim 19, wherein
the first determination region and the second determination region are adjacent to each other, and
the processing includes widening the first determination region toward a side of the second determination region and narrowing the second determination region in a case where the detection object is located in the first determination region.
